(19) United States
(12) Patent Application Publication
(10) Pub. No.: US 2024/0027740 A1
(43) Pub. Date: Jan. 25, 2024

(54) ZOOM LENS AND IMAGE CAPTURING APPARATUS

(71) Applicant: CANON KABUSHIKI KAISHA, Tokyo (JP)

(72) Inventor: NAOTOSHI OGAWA, Tochigi (JP)

(21) Appl. No.: 18/352,836

(22) Filed: Jul. 14, 2023

(30) Foreign Application Priority Data
Jul. 20, 2022 (JP) 2022-115908

(51) Int. Cl. G02B 15/20

(52) U.S. Cl. CPC G02B 15/20

(57) ABSTRACT

A zoom lens includes, in order from an object side to an image side, a first lens unit having positive refractive power, the first lens unit being configured not to move for zooming, an intermediate group including a plurality of lens units, the plurality of lens units being configured to move for zooming, and a rear lens unit. An interval between adjacent lens units changes for zooming. The intermediate group includes a lens unit having negative refractive power including a negative lens LN that satisfies the following inequalities:

1.60<ndLN<2.00

25.0<vdLN<60.0

0.490<θCtLN−0.00417×vdLN<0.550

where ndLN is a refractive index of a material of the negative lens LN for d-line, vdLN is Abbe number of the material for d-line, and OCtLN is a partial dispersion ratio of the material for C-line and t-line.

### BACKGROUND

### Technical Field

The aspect of the embodiments relates to zoom lenses and image capturing apparatuses.

### Description of the Related Art

In recent years, zoom lenses for use in image capturing apparatuses are desired to have a high zoom ratio and compact size. Zoom lenses for monitoring cameras are further desired to be configured to capture images with high optical performance both day and night. Monitoring cameras can use visible light for daytime image capturing and near-infrared light for night image capturing. The image capturing using near-infrared light is less affected by scattering due to heavy fog than image capturing using visible light. For this reason, zoom lenses for monitoring cameras may be corrected for aberration in a wide wavelength band from a visible range to a near-infrared range. For use in monitoring both a wide range and a faraway region, a high zoom ratio and luminance are required.

Japanese Patent Laid-Open No. 2016-95448 discloses a zoom lens with a high zoom ratio including, in order from an object side to an image side, first to fourth lens units respectively having positive, negative, negative, and positive refractive power in which the interval between adjacent lens units changes in zooming. Japanese Patent Laid-Open No. 2021-76781 discloses a zoom lens with a high zoom ratio including, in order from an object side to an image side, first to fourth lens units respectively having positive, negative, positive, and positive refractive power in which the interval between adjacent lens units changes in zooming.

Of near-infrared light, short wavelength infrared (SWIR) light having a wavelength from 1,000 nm to 2,500 nm is highly useful for monitoring cameras. This increases a request for zoom lenses in which their chromatic aberration is corrected for a wavelength range from a visible range to an SWIR range. For such wide-range correction of chromatic aberration, zoom lenses tend to increase in size, making it difficult to satisfy a request for compact monitoring cameras.

### SUMMARY

A zoom lens includes, in order from an object side to an image side: a first lens unit having positive refractive power; the first lens unit being configured not to move for zooming, an intermediate group including a plurality of lens units, the plurality of lens units being configured to move for zooming; and a rear lens unit, wherein an interval between adjacent lens units changes for zooming, wherein the intermediate group includes a lens unit having negative refractive power including a negative lens LN that satisfies the following inequalities:

1.60<ndLN<2.00

25.0<vdLN<60.0

0.490<θCtLN−0.00417×vdLN<0.550

where ndLN is a refractive index of a material of the negative lens LN for d-line, vdLN is Abbe number of the material of the negative lens LN for d-line, and OCtLN is a partial dispersion ratio of the material of the negative lens LN for C-line and t-line, and wherein the following inequality is satisfied:

−0.050<θCtNmp−θCtNmn<0.050

where θCtNmp is an average value of partial dispersion ratios, for C-line and t-line, of all positive lenses included in a lens unit Nm including a negative lens LNm having strongest negative refractive power of the negative lens LN, and θCtNmn is an average value of partial dispersion ratios, for C-line and t-line, of all negative lenses included in the lens unit Nm.

Further features of the disclosure will become apparent from the following description of exemplary embodiments with reference to the attached drawings.

### BRIEF DESCRIPTION OF THE DRAWINGS

FIG. 1 is a cross-sectional view of a zoom lens according to a first embodiment at a wide-angle end in focusing on an object at infinity.

FIG. 2A is an aberration chart at a wide-angle end in focusing on an object at infinity.

FIG. 2B is an aberration chart at an intermediate point in focusing on an object at infinity.

FIG. 2C is an aberration chart at a telephoto end in focusing on an object at infinity.

FIG. 3 is a cross-sectional view of a zoom lens according to a second embodiment at a wide-angle end in focusing on an object at infinity.

FIG. 4A is an aberration chart at a wide-angle end in focusing on an object at infinity.

FIG. 4B is an aberration chart at an intermediate point in focusing on an object at infinity.

FIG. 4C is an aberration chart at a telephoto end in focusing on an object at infinity.

FIG. 5 is a cross-sectional view of a zoom lens according to a third embodiment at a wide-angle end in focusing on an object at infinity.

FIG. 6A is an aberration chart at a wide-angle end in focusing on an object at infinity.

FIG. 6B is an aberration chart at an intermediate point in focusing on an object at infinity.

FIG. 6C is an aberration chart at a telephoto end in focusing on an object at infinity.

FIG. 7 is a cross-sectional view of a zoom lens according to a fourth embodiment at a wide-angle end in focusing on an object at infinity.

FIG. 8A is an aberration chart at a wide-angle end in focusing on an object at infinity.

FIG. 8B is an aberration chart at an intermediate point in focusing on an object at infinity.

FIG. 8C is an aberration chart at a telephoto end in focusing on an object at infinity.

FIG. 9 is a cross-sectional view of a zoom lens according to a sixth embodiment at a wide-angle end in focusing on an object at infinity.

FIG. 10A is an aberration chart at a wide-angle end in focusing on an object at infinity.

FIG. 10B is an aberration chart at an intermediate point in focusing on an object at infinity.

FIG. 10C is an aberration chart at a telephoto end in focusing on an object at infinity.

FIG. 11 is a cross-sectional view of a zoom lens according to a fifth embodiment at a wide-angle end in focusing on an object at infinity.

FIG. 12A is an aberration chart at a wide-angle end in focusing on an object at infinity.

FIG. 12B is an aberration chart at an intermediate point in focusing on an object at infinity.

FIG. 12C is an aberration chart at a telephoto end in focusing on an object at infinity.

FIG. 13 is a cross-sectional view of a zoom lens according to a seventh embodiment at a wide-angle end in focusing on an object at infinity.

FIG. 14A is an aberration chart at a wide-angle end in focusing on an object at infinity.

FIG. 14B is an aberration chart at an intermediate point in focusing on an object at infinity.

FIG. 14C is an aberration chart at a telephoto end in focusing on an object at infinity.

FIG. 15 is a diagram illustrating a configuration example of an image capturing apparatus.

### DESCRIPTION OF THE EMBODIMENTS

Embodiments of the disclosure will be described hereinbelow with reference to the accompanying drawings. Like components are given like reference signs throughout all the drawings for illustrating the embodiments in principle (unless otherwise noted), and repetitive descriptions thereof will be omitted.

### EMBODIMENTS

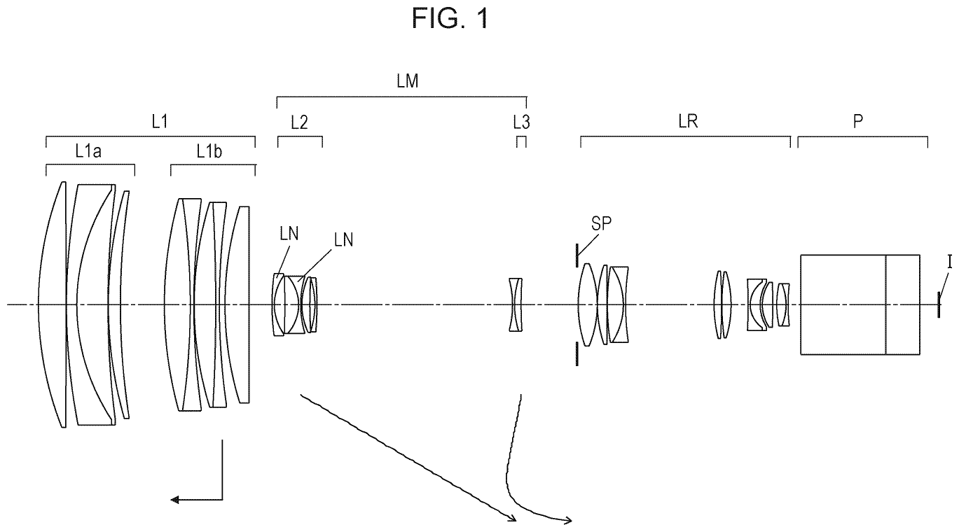

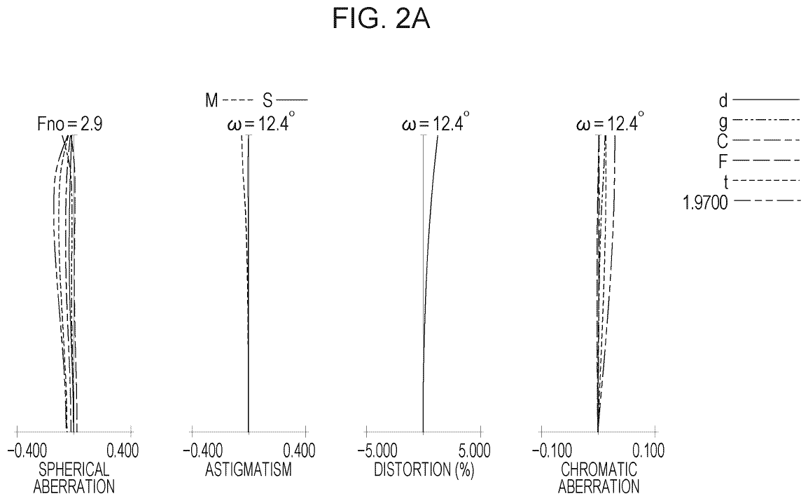

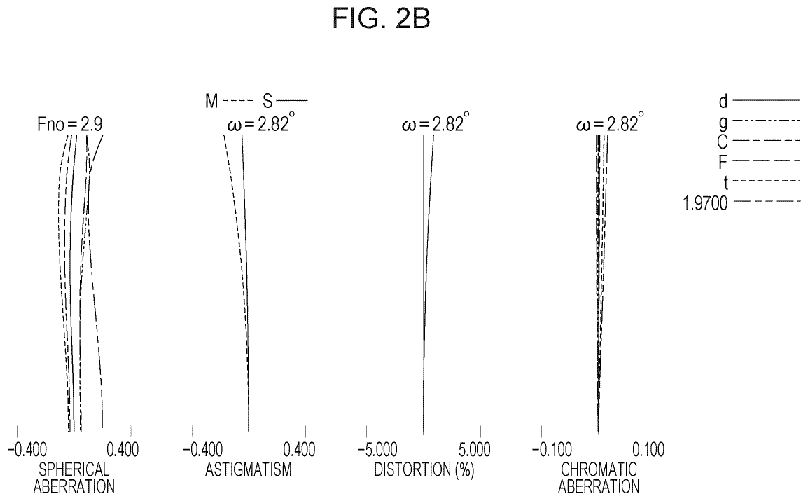

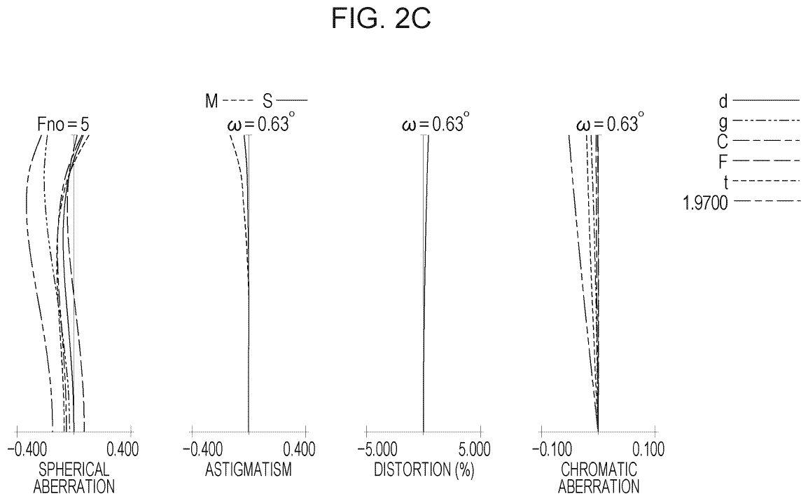

FIG. 1 is a cross-sectional view of a zoom lens at a wide-angle end in focusing on an object at infinity according to a first embodiment, described later. The first embodiment corresponds to Numerical Example 1 described later. FIGS. 2A to 2C are aberration charts in focusing on an object at infinity at a wide-angle end, an intermediate point, and a telephoto end, respectively, in Numerical Example 1 (their respective focal lengths are shown in Numerical Example 1). In the aberration charts, the straight line, the two-dot chain line, the one-dot chain line, the long broken line, the short broken line, and the long two-dot chain line for the spherical aberration correspond to d-line, g-line, C-line, F-line, t-line, and a wavelength 1,970 nm, respectively. The wavelength of d-line is 587.6 nm, the wavelength of g-line is 435.8 nm, the wavelength of C-line is 656.3 nm, the wavelength of F-line is 486.1 nm, and the wavelength of t-line is 1,014.0 nm. The broken line and the solid line for the astigmatism correspond to a meridional image plane and a sagittal image plane, respectively. The distortion aberration corresponds to d-line. The solid line, the two-dot chain line, the one-dot chain line, and the broken line for the magnification chromatic aberration correspond to d-line, g-line, C-line, and F-line, respectively. Fno denotes F-number, and w denotes a half angle of view. The spherical aberration is expressed as ±0.400 mm on the full scale of the horizontal axis. The astigmatism is expressed as ±0.400 mm on the full scale of the horizontal axis. The distortion aberration is expressed as ±5.000% on the full scale of the horizontal axis. The magnification chromatic aberration is expressed as ±0.100 mm on the full scale of the horizontal axis.

The components of the zoom lens will be described from the object side to the image side with reference to FIG. 1. Reference sign L1 denotes a first lens unit having positive refractive power, which does not move for zooming A first sub-lens unit L1a in the first lens unit L1 does not move for focusing. A second sub-lens unit L1b in the first lens unit L1 moves to the object side for focusing from an object at infinity to an object at close range.

Reference LM denotes an intermediate group including a plurality of lens units that moves in zooming. Reference sign L2 in the intermediate group LM denotes a second lens unit having negative refractive power, which moves in zooming, and L3 denotes a third lens unit having negative refractive power, which moves in zooming.

The second lens unit L2 moves monotonically on the optical axis to the image side for zooming from the wide-angle end to the telephoto end, as shown in the drawing. The third lens unit L3 moves non-monotonically on the optical axis for zooming from the wide-angle end to the telephoto end. Reference sign SP denotes an aperture stop, which does not move in zooming. Reference sign LR denotes a rear lens unit (a relay lens unit) having positive refractive power, which does not move for zooming. Reference sign I denotes an image plane (a plane on which an image is formed) of the zoom lens. The image sensor P captures the image (performs image capturing). In the zoom lens, the interval between adjacent lens units changes in zooming. The aperture stop SP can be disposed between the intermediate group LM and the rear lens unit LR or between the last lens unit and the second last lens unit in the intermediate group LM. The aperture stop SP can be disposed in the rear lens unit LR or the last lens unit in the intermediate group LM. In FIG. 1, the arrows in the intermediate group LM indicate the movement trajectory of the lens units in zooming from the wide-angle end to the telephoto end, and the hooked arrow indicates the moving direction of the sub-lens unit for focusing from the infinite end to the close end (this applies also to the cross-sectional views of the other zoom lenses).

The zoom lens according to this embodiment includes, from the object side to the image side, the first lens unit L1 having positive refractive power, which does not move for zooming, the intermediate group LM including a plurality of lens units, which moves for zooming, and a rear lens unit. The interval between adjacent lens units of the zoom lens changes for zooming. The intermediate group LM includes a negative lens unit including a negative lens LN (a lens unit having negative refractive power) that satisfies the following inequalities:

1.60<ndLN<2.00 (1)

25.0<vdLN<60.0 (2)

0.490<θCtLN−0.00417×vdLN<0.550 (3)

where ndLN is the refractive index of the negative lens (a lens having negative refractive power) LN for d-line, vdLN is the Abbe number of the negative lens LN for d-line, and OCtLN is the partial dispersion ratio of the negative lens LN for C-line and t-line.

This embodiment provides a zoom lens that is advantageous in achieving high optical performance and compact size in a wavelength band from visible light to SWIR light. In the first embodiment, the second lens unit L2 having negative refractive power includes the negative lens LN that satisfies Inequalities (1) to (3).

The Abbe number vd and the partial dispersion ratio θCt are expressed as:

vd=(nd−1)/(nF−nC)

θCt=(nC−nt)/(nF−nC)

where nF, nC, nd, and nt are the respective refractive indies of the material for F-line (486.1 nm), C-line (656.3 nm), d-line (wavelength 587.6 nm), and t-line (1,014.0 nm).

The refractive index nd for d-line, the Abbe number vd for d-line, and the partial dispersion ratio θCt for C-line and t-line are also simply referred to as refractive index nd, Abbe number vd, partial dispersion ratio θCt, respectively.

The technical meaning of Inequalities (1) to (3) will be described. Inequalities (1) to (3) express conditions for providing a zoom lens that is advantageous in achieving high optical performance and compact size in a wavelength band from visible light to SWIR light. If the condition of Inequality (1) is not satisfied for the upper limit, a material with excessively high dispersiveness is selected as a material for the negative lenses LN, which causes excessively large variation in chromatic aberration in zooming. If the condition of Inequality (1) is not satisfied for the lower limit, the curvature radius of the negative lens LN decreases excessively, which excessively increases the size of the lens. This excessively increases the size of the zoom lens or makes it difficult to provide a zoom lens having a high zoom ratio. If the condition of Inequality (2) is not satisfied for the upper limit, a material with excessively low dispersiveness is selected, which excessively increases the size of the zoom lens or makes it difficult to provide a zoom lens having a high zoom ratio. If the condition of Inequality (2) is not satisfied for the lower limit, a material with excessively high dispersiveness is selected, which causes excessively large variation in chromatic aberration in zooming. If the condition of Inequality (3) is not satisfied, excessively large variation in secondary chromatic aberration occurs in zooming.

Examples of a glass material that satisfies Inequalities (1) to (3) include S-LAL20 made by Ohara Inc. and K-GIR79 and K-GIR140 made by Sumita Optical Glass, Inc. The zoom lens according to this embodiment satisfies the following inequality:

0.3<fLN1/fN1<5.0 (4).

where fN1 is the focal length of a lens unit N1 having the strongest negative refractive power (negative refractive power with the greatest absolute value, the same shall apply hereinafter) among the plurality of lens units included in the intermediate group LM. A lens unit with the focal length fN1 includes the negative lenses LN. Sign fLN1 denotes the focal length of a negative lens LN1 having the strongest negative refractive power of the negative lenses LN in the lens unit N1.

Inequality (4) expresses a condition for providing a zoom lens that is advantageous in achieving high optical performance and compact size in a wavelength band from visible light to SWIR light. If the condition of Inequality (4) is not satisfied for the upper limit, the refractive power of the negative lenses LN decreases excessively, which causes excessively large variation in chromatic aberration in zooming. If the condition of Inequality (4) is not satisfied for the lower limit, the refractive power of the negative lenses LN increases excessively, which causes excessively large variation in aberrations (including a chromatic aberration) in zooming.

In one embodiment, the zoom lens satisfies the following inequality:

−12.0<f1/fN1<−2.0 (5)

where f1 is the focal length of the first lens unit L1.

Inequality (5) expresses a condition for providing a zoom lens that is advantageous in achieving a high zoom ratio, compact size, and high optical performance. If the condition of Inequality (5) is not satisfied for the upper limit, the refractive power of the lens unit N1 having the strongest negative refractive power among the plurality of lens units included in the intermediate group LM increases excessively, which causes excessively large variation in aberration in zooming. If the condition of Inequality (5) is not satisfied for the lower limit, the refractive power of the lens unit N1 having the strongest negative refractive power among the plurality of lens units included in the intermediate group LM decreases excessively. This excessively increases the amount of movement of the lens unit N1 having the strongest negative refractive power among the plurality of lens units included in the intermediate group LM, which excessively increases the size of the zoom lens or makes it difficult to provide a zoom lens having a high zoom ratio.

The zoom lens according to this embodiment satisfies the following inequality:

1.55<ndN1a<1.90 (6)

where ndN1a is the average value of the refractive indices of all the lenses included in the lens unit N1 having the strongest negative refractive power for d-line among the plurality of lens units included in the intermediate group LM.

Inequality (6) expresses a condition for providing a zoom lens that is advantageous in achieving a high zoom ratio, compact size, and high optical performance. If the condition of Inequality (6) is not satisfied for the upper limit, a material with high dispersiveness is selected for the lenses included in the lens unit N1, which causes excessively large variation in chromatic aberration in zooming. If the condition of Inequality (6) is not satisfied for the lower limit, the curvature radius of the lenses included in the lens unit N1 decreases excessively, which excessively increases the size of the lenses. variation in chromatic aberration in zooming. This excessively increases the size of the zoom lens or makes it difficult to provide a zoom lens having a high zoom ratio.

The zoom lens according to this embodiment satisfies the following inequality:

−40.0<vdN1p−vdN1n<−5.0 (7)

where vdN1p is the average value of the Abbe numbers of all the lenses having positive refractive power included in the lens unit N1 having the strongest negative refractive power among the plurality of lens units included in the intermediate group LM, and vdN1n is the average value of the Abbe numbers of all the lenses having negative refractive power included in the lens unit N1.

Inequality (7) expresses a condition for providing a zoom lens that is advantageous in achieving a high zoom ratio, compact size, and high optical performance. If the condition of Inequality (7) is not satisfied for the upper limit, excessively large variation occurs in aberration in zooming, or the refractive power of the lenses in the lens unit N1 increases excessively, which causes excessive variation in the aberrations (including a chromatic aberration) in zooming. If the condition of Inequality (7) is not satisfied for the lower limit, materials with an excessive difference in partial dispersion ratio θCt are selected for a positive lens and a negative lens included in the lens unit N1, which causes excessively large variation in secondary chromatic aberration in zooming.

The zoom lens according to this embodiment satisfies the following inequality:

−0.050<θCtN1p−θCtN1n<0.050 (8)

where θCtN1p is the average value of the partial dispersion ratios θCt of all the lenses having positive refractive power included in the lens unit N1 having the strongest negative refractive power among the plurality of lens units included in the intermediate group LM, and θctN1n is the average value of the partial dispersion ratios θCt of all the lenses having negative refractive power included in the lens unit N1.

Inequality (8) expresses a condition for providing a zoom lens that is advantageous in achieving high optical performance in a wavelength band from visible light to SWIR light. If the condition of Inequality (8) is not satisfied, excessively large variation in secondary chromatic aberration occurs in zooming.

The zoom lens according to this embodiment satisfies the following inequality:

0.3<fLNm/fNm<4.0 (9)

where fNm is the focal length of a lens unit Nm including a negative lens LNm having the strongest negative refractive power in the negative lenses LN, and fLNm is the focal length of the negative lens LNm.

Inequality (9) expresses a condition for providing a zoom lens that is advantageous in achieving high optical performance and compact size in a wavelength band from visible light to SWIR light. If the condition of Inequality (9) is not satisfied for the upper limit, the refractive power of the negative lenses LN decreases excessively, which causes excessively large variation in chromatic aberration in zooming. If the condition of Inequality (9) is not satisfied for the lower limit, the refractive power of the negative lenses LN increases excessively, which causes excessively large variation in aberrations (including a chromatic aberration) in zooming.

The zoom lens according to this embodiment satisfies the following inequality:

1.55<ndNma<1.90 (10)

where ndNma is the average value of refractive indices for d-line of all the lenses included in the lens unit Nm including a negative lens LNm having the strongest negative refractive power in the negative lenses LN.

Inequality (10) expresses a condition for providing a zoom lens that is advantageous in achieving a high zoom ratio, compact size, and high optical performance. If the condition of Inequality (10) is not satisfied for the upper limit, a material with excessively high dispersiveness is selected the lenses included in the lens unit Nm, which causes excessively large variation in chromatic aberration in zooming. If the condition of Inequality (10) is not satisfied for the lower limit, the curvature radius of the lenses included in the lens unit Nm decreases excessively, which excessively increases the size of the zoom lens or makes it difficult to provide a zoom lens having a high zoom ratio.

The zoom lens according to this embodiment satisfies the following inequality:

−40.0<vdNmp−vdNmn<−5.0 (11)

where vdNmp is the average value of the Abbe numbers of all the lenses having positive refractive power included in the lens unit Nm including a negative lens LNm having the strongest negative refractive power in the negative lenses LN, and vdNmn is the average value of the Abbe numbers of the lenses having negative refractive power included in the lens unit Nm.

Inequality (11) expresses a condition for providing a zoom lens that is advantageous in achieving a high zoom ratio, compact size, and high optical performance. If the condition of Inequality (11) is not satisfied for the upper limit, excessively large variation in chromatic aberration occurs in zooming, or the refractive power of the lenses in the lens unit Nm increases excessively, which causes excessive variation in the aberrations (including a chromatic aberration) in zooming. If the condition of Inequality (11) is not satisfied for the lower limit, materials with an excessive difference in partial dispersion ratio θCt are selected for a positive lens and a negative lens included in the lens unit Nm, which causes excessively large variation in secondary chromatic aberration in zooming.

The zoom lens according to this embodiment satisfies the following inequality:

−0.050<θCtNmp−θCtNmn<0.050 (12)

where θCtNmp is the average value of the partial dispersion ratios θCt of all the lenses having positive refractive power included in the lens unit Nm including a negative lens LNm having the strongest negative refractive power in the negative lenses LN, and θCtNmn is the average value of the partial dispersion ratios θCt of all the lenses having negative refractive power included in the lens unit Nm.

Inequality (12) expresses a condition for providing a zoom lens that is advantageous in achieving high optical performance in a wavelength band from visible light to SWIR light. If the condition of Inequality (12) is not satisfied, excessively large variation in secondary chromatic aberration occurs in zooming.

The intermediate group LM includes, from the object side to the image side, a sub-intermediate unit V having negative refractive power and including at least one lens unit that moves monotonically to the image side for zooming, and at least one lens unit. The sub-intermediate unit V includes the negative lenses LN. The zoom lens according to this embodiment satisfies the following inequality:

0.3<fLNVm/fV<4.0 (13)

where fV is the focal length (combined focal length) of the sub-intermediate unit V at the wide-angle end, and fLNVm is the focal length of a negative lens LNVm having the strongest negative refractive power of the negative lenses LN in the sub-intermediate unit V.

Inequality (13) expresses a condition for providing a zoom lens that is advantageous in achieving high optical performance in a wavelength band from visible light to SWIR light and compact size. If the condition of Inequality (13) is not satisfied for the upper limit, the refractive power of the negative lenses LNVm decreases excessively, which causes excessively large variation in chromatic aberration in zooming. If the condition of Inequality (13) is not satisfied for the lower limit, the refractive power of the negative lenses LNVm increases excessively, which causes excessively large variation in the aberrations (including a chromatic aberration) in zooming.

The intermediate group LM includes, from the object side to the image side, a sub-intermediate unit V having negative refractive power and including at least one lens unit that moves monotonically to the image side for zooming, and at least one lens unit.

The zoom lens according to this embodiment satisfies the following inequality:

−12.0<f1/fv<−2.0 (14)

where f1 is the focal length of the first lens unit L1, and fv is the focal length (combined focal length) of the sub-intermediate unit V at the wide-angle end.

Inequality (14) expresses a condition for providing a zoom lens that is advantageous in achieving a high zoom ratio, compact size, and high optical performance. If the condition of Inequality (14) is not satisfied for the upper limit, the refractive power of the sub-intermediate unit V decreases excessively, and the amount of movement of the sub-intermediate unit V increases excessively, which excessively increases the size of the zoom lens or makes it difficult to provide a zoom lens having a high zoom ratio. If the condition of Inequality (14) is not satisfied for the lower limit, the refractive power of the sub-intermediate unit V increases excessively, which causes excessively large variation in the aberrations in zooming.

The intermediate group LM includes, from the object side to the image side, a sub-intermediate unit V having negative refractive power and including at least one lens unit that moves monotonically to the image side for zooming, and at least one lens unit.

The zoom lens according to this embodiment satisfies the following inequality:

1.55<ndVa<1.9 (15)

where ndVa is the average value of the refractive indices for d-line of all the lenses included in the sub-intermediate unit V.

Inequality (15) expresses a condition for providing a zoom lens that is advantageous in achieving a high zoom ratio, compact size, and high optical performance. If the condition of Inequality (15) is not satisfied for the upper limit, a material with excessively high dispersiveness is selected for the lenses included in the sub-intermediate unit V, which causes excessively large variation in chromatic aberration in zooming. If the condition of Inequality (15) is not satisfied for the lower limit, the curvature radius of the lenses included in the sub-intermediate unit V decreases excessively, which excessively increases the size of the zoom lens or makes it difficult to provide a zoom lens having a high zoom ratio.

The intermediate group LM includes, from the object side to the image side, a sub-intermediate unit V having negative refractive power and including at least one lens unit that moves monotonically to the image side for zooming, and at least one lens unit. The zoom lens according to this embodiment satisfies the following inequality:

−40.0<vdVp−vdVn<−5.0 (16)

where vdVp is the average value of the Abbe numbers of all the lenses having positive refractive power included in the sub-intermediate unit V, and vdVn is the average value of the Abbe numbers of all the lenses having negative refractive power included in the sub-intermediate unit V.

Inequality (16) expresses a condition for providing a zoom lens that is advantageous in achieving a high zoom ratio, compact size, and high optical performance. If the condition of Inequality (16) is not satisfied for the upper limit, excessively large variation occurs in chromatic aberration in zooming, or the refractive power of the lenses included in the sub-intermediate unit V increases excessively, which causes excessive variation in the aberrations (including a chromatic aberration) in zooming. If the condition of Inequality (16) is not satisfied for the lower limit, materials with an excessive difference in partial dispersion ratio are selected for a positive lens and a negative lens included in the sub-intermediate unit V, which causes excessively large variation in secondary chromatic aberration in zooming.

The intermediate group LM includes, from the object side to the image side, a sub-intermediate unit V having negative refractive power and including at least one lens unit that moves monotonically to the image side for zooming, and at least one lens unit.

The zoom lens according to this embodiment satisfies the following inequality:

−0.050<θCtVp−θCtVn<0.050 (17)

where θCtVp is the average value of the partial dispersion ratios θCt of all the lenses having positive refractive power included in the sub-intermediate unit V, and θCtVn is the average value of the partial dispersion ratios θCt of all the lenses having negative refractive power included in the sub-intermediate unit V.

Inequality (17) expresses a condition for providing a zoom lens that is advantageous in achieving high optical performance in a wavelength band from visible light to SWIR light. If the condition of Inequality (17) is not satisfied, excessively large variation in secondary chromatic aberration occurs in zooming.

The zoom lens according to this embodiment satisfies the following inequality:

−0.030<θCt1p−θCt1n<0.030 (18)

where θCt1p is the average value of the partial dispersion ratios θCt of all the lenses having positive refractive power included in the first lens unit L1, and θCt1n is the average value of the partial dispersion ratios θCt of the all the lenses having negative refractive power included in the first lens unit L1.

Inequality (18) expresses a condition for providing a zoom lens that is advantageous in achieving high optical performance in a wavelength band from visible light to SWIR light. If the condition of Inequality (18) is not satisfied, excessively large variations occur in a secondary axial chromatic aberration at the telephoto end and a secondary chromatic aberration in zooming.

In one embodiment, the zoom lens satisfies Inequalities (1a) to (18a).

1.65<ndLN<1.90 (1a)

30.0<vdLN<55.0 (2a)

0.500<θCtLN−0.00417×vdLN<0.549 (3a)

0.5<fLN1/fN1<3.0 (4a)

−10.0<f1/fN1<−2.5 (5a)

1.60<ndN1a<1.88 (6a)

−35.0<vdN1p−vdN1n<−8.0 (7a)

−0.045<θCtN1pθCtN1n<0.045 (8a)

0.5<fLNm/fNm<3.0 (9a)

1.60<ndNma<1.88 (10a)

−35.0<vdNmp−vdNmn<−8.0 (11a)

−0.045<θCtNmp−θCtNmn<0.045 (12a)

0.5<fLNVm/fV<3.0 (13a)

−10.0<f1/fv<−2.5 (14a)

1.60<ndVa<1.88 (15a)

−35.0<vdVp−vdVn<−8.0 (16a)

−0.045<θCtVp−θCtVn<0.045 (17a)

−0.015<θCt1p−θCt1n<0.015 (18a)

### Embodiments of Image Capturing Apparatus

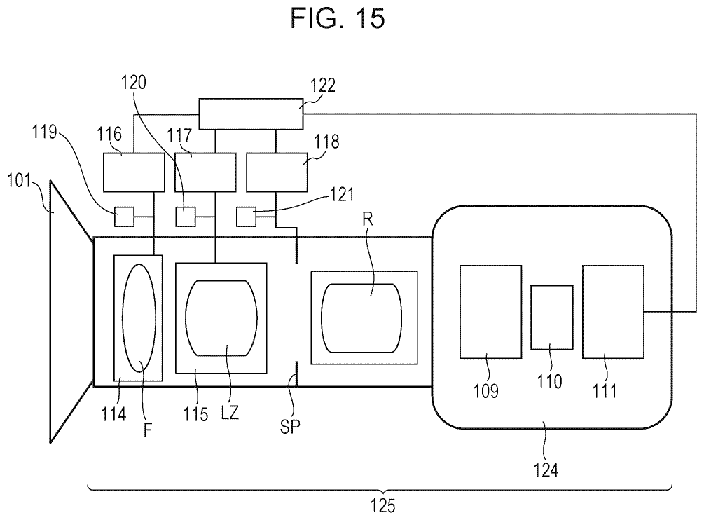

FIG. 15 is a diagram illustrating a configuration example of an image capturing apparatus. In FIG. 15, reference sign 101 denotes the zoom lens of any of the first to seventh embodiments. Reference sign 124 denotes a camera (an image capturing unit, or an image capturing apparatus main body). The zoom lens 101 is detachably attached to the camera 124. Reference sign 125 denotes an image capturing apparatus formed by attaching the zoom lens 101 to the camera 124. The zoom lens 101 includes a first lens unit, an intermediate group including a plurality of lens units, which moves for zooming, and a rear lens unit, which does not move for zooming. In FIG. 15, the first lens unit is denoted by F, the intermediate group is denoted by LZ, and the rear lens unit is denoted by R. The first lens unit may include a sub-lens unit, which moves for focusing, as described above. In FIG. 15, SP denotes an aperture stop, 114 and 115 denote a driving mechanism including, for example, a helicoid or a cam, for driving the sub-lens unit for focusing and the lens unit for zooming, respectively. Reference signs 116 to 118 denote motors (actuators) for driving the driving mechanisms 114 and 115 and the aperture stop SP, respectively. Reference signs 119 to 121 denote detecting units including, for example, an encoder, a potentiometer, and a photosensor, for detecting the positions of the sub-lens unit for focusing and the lens unit for zooming and the aperture diameter of the aperture stop SP, respectively.

The camera 124 includes a glass block 109 including, for example, an optical filter and an image sensor (a photoelectric conversion element) 110 including, for example, a charge-coupled device (CCD) or a complementary metal-oxide-semiconductor (CMOS) device. The image sensor 110 captures an object image formed by the zoom lens 101. Reference signs 111 and 122 denote processing units including a processor, such as a central processing unit (CPU), for performing various processes and control operations for the camera 124 and the zoom lens 101, respectively. This embodiment provides a useful image capturing apparatus having the advantageous effects of the zoom lenses according to the above embodiments.

First to seventh embodiments and Numerical Examples 1 to 7 corresponding to the first to seventh embodiments, respectively, will be described hereinbelow.

### First Embodiment

In FIG. 1, the configurations of the lens unit and the sub-lens unit according to the first embodiment are as described above. In FIG. 1, the first lens unit L1 has first to 15th surfaces. The first sub-lens unit L1a has the first to seventh surfaces and consists of one negative lens and three positive lenses.

The second sub-lens unit L1b has eighth to 15th surfaces and consists of two negative lenses and three positive lenses. The intermediate group LM consists of the second lens unit L2 and the third lens unit L3. The second lens unit L2 has 16th to 24th surfaces and consists of three negative lenses and two positive lenses. The third lens unit L3 has 25th to 27th surfaces and consists of one negative lens and one positive lens. The aperture stop SP has a 28th surface. The rear lens unit LR has 29th to 47th surfaces and consists of one positive lens having an aspherical surface on the image side, three negative lenses, and seven positive lenses. FIGS. 2A to 2C are aberration charts of Numerical Example 1, as described above.

In this embodiment, the negative lens LN includes a lens having 16th and 17the surfaces in the second lens unit L2 and a lens having 19th and 20th surfaces in the second lens unit L2. In this embodiment, the second lens unit L2 has the greatest negative refractive power in the intermediate group LM.

In this embodiment, the negative lens LNm having the strongest negative refractive power of the negative lenses LN is the lens having the 19th and 20th surfaces in the second lens unit L2. In this embodiment, the sub-intermediate unit V consists of the second lens unit L2.

The values in Inequalities (1) to (18) of this embodiment are shown in Table 1. The values of the variables in Inequalities (1) to (18) are shown in Table 2. This embodiment provides a zoom lens that satisfies all of Inequalities (1) to (18) and is therefore advantageous in achieving high optical performance in a wavelength band from visible light to SWIR light and compact size. The zoom lens is provided by satisfying Inequalities (1) to (3) and does not necessarily have to satisfy Inequalities (4) to (18). If at least any one of Inequalities (4) to (18), in addition to Inequalities (1) to (3), is satisfied, a more prominent effect or an effect of a different nature is provided than otherwise. The advantageous effects provided when the inequalities are satisfied are described above.

### Second Embodiment

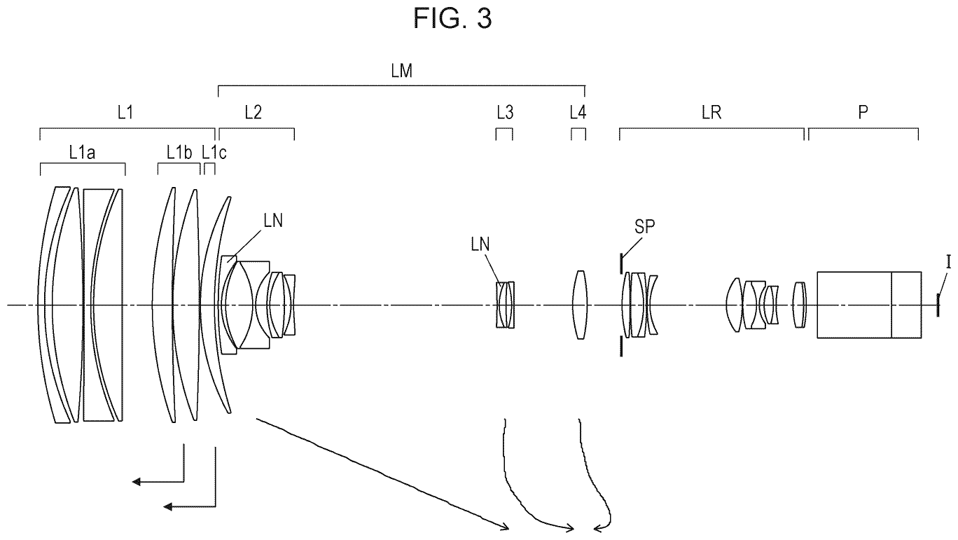

FIG. 3 is a cross-sectional view of a zoom lens according to a second embodiment at the wide-angle end in focusing on an object at infinity. The components of the zoom lens will be described in order from the object side to the image side with reference to FIG. 3. Reference sign L1 denotes a first lens unit having positive refractive power, which does not move for zooming. A first sub-lens unit L1a in the first lens unit L1 does not move for focusing. A second sub-lens unit L1b in the first lens unit L1 moves to the object side for focusing from an object at infinity to an object at a close range. A third sub-lens unit L1c in the first lens unit L1 moves to the object side on a trajectory different from the second sub-lens unit L1b for focusing from an object at infinity to an object at a close range. Reference LM denotes an intermediate group including a plurality of lens units, which moves in zooming. Reference sign L2 in the intermediate group LM denotes a second lens unit having negative refractive power, which moves in zooming, L3 in the intermediate group LM denotes a third lens unit having negative refractive power, which moves in zooming, and L4 in the intermediate group LM denotes a fourth lens unit having positive refractive power, which moves in zooming. The second lens unit L2 moves monotonically to the image side in zooming from the wide-angle end to the telephoto end. The third lens unit L3 moves first to the object side and then to the image side in the zooming. The fourth lens unit L4 moves (non-monotonically as shown) in the zooming. Reference sign SP denotes an aperture stop, which does not move for zooming. Reference sign LR denotes a rear lens unit having positive refractive power, which does not move for zooming.

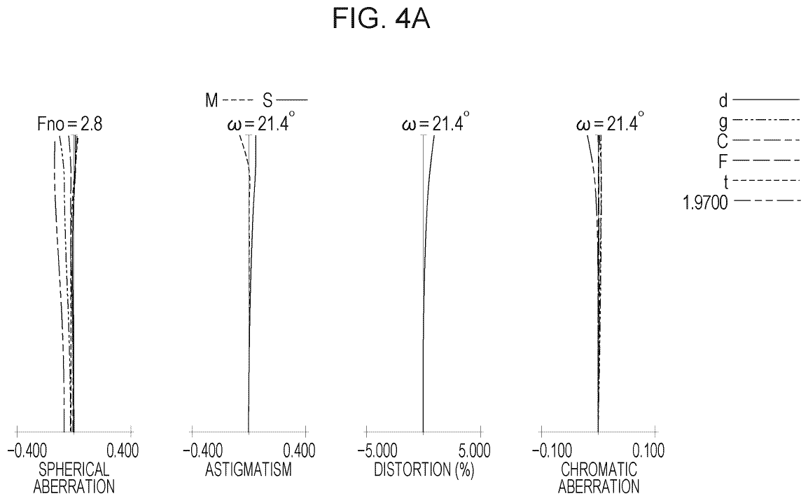

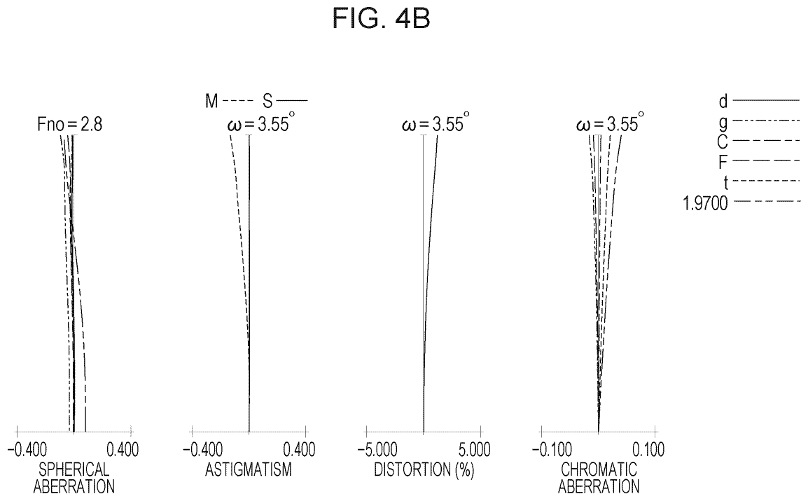

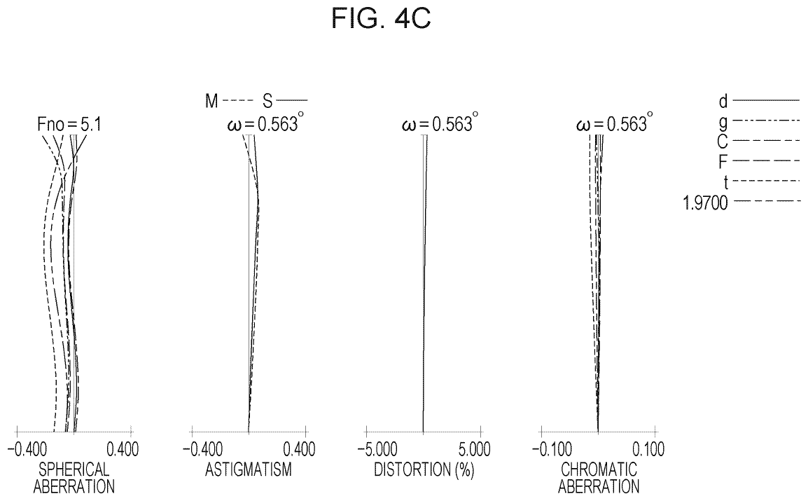

The first lens unit L1 has first to 14th surfaces. The first sub-lens unit L1a has first to eighth surfaces and consists of two negative lenses and two positive lenses. The second sub-lens unit L1b has ninth to 12th surfaces and consists of two positive lenses. The third sub-lens unit L1c has 13th and 14th surfaces and consists of one positive lens. The second lens unit L2 has 15th to 24th surfaces and consists of one negative lens having an aspherical surface on the image side, two positive lenses, and two negative lenses. The third lens unit L3 has 25th to 29th surfaces and consists of one positive lens and two negative lenses. The fourth lens unit L4 has 30th and 31st surfaces and consists of one positive lens having an aspherical surface on the object side. The aperture stop SP has a 32nd surface. The rear lens unit LR has 33rd to 50th surfaces and consists of five negative lenses and six positive lenses. FIGS. 4A to 4C are aberration charts in focusing on an object at infinity at a wide-angle end, at an intermediate point, and a telephoto end, respectively (their respective focal lengths are shown in Numerical Example 2). Its explanatory note is the same as that described with reference to FIGS. 2A to 2C.

In this embodiment, the lenses LN are the lens having the 15th and 16th surfaces in the second lens unit L2 and the lens having the 25th and 26th surfaces in the third lens unit L3. In this embodiment, a lens unit having the strongest negative refractive power in the intermediate group LM is the second lens unit L2. In this embodiment, the negative lens LNm having the strongest negative refractive power in the negative lenses LN is the lens having the 25th and 26th surfaces in the third lens unit L3. In this embodiment, the sub-intermediate unit V is the second lens unit L2.

The values in Inequalities (1) to (18) of this embodiment are shown in Table 1. The values of the variables in Inequalities (1) to (18) are shown in Table 2. This embodiment provides a zoom lens that satisfies all of Inequalities (1) to (18) and is therefore advantageous in achieving high optical performance in a wavelength band from visible light to SWIR light and compact size. The zoom lens is provided by satisfying Inequalities (1) to (3) and does not necessarily have to satisfy Inequalities (4) to (18). If at least any one of Inequalities (4) to (18), in addition to Inequalities (1) to (3), is satisfied, a more prominent effect or an effect of a different nature is provided than otherwise. The advantageous effects provided when the inequalities are satisfied are described above.

### Third Embodiment

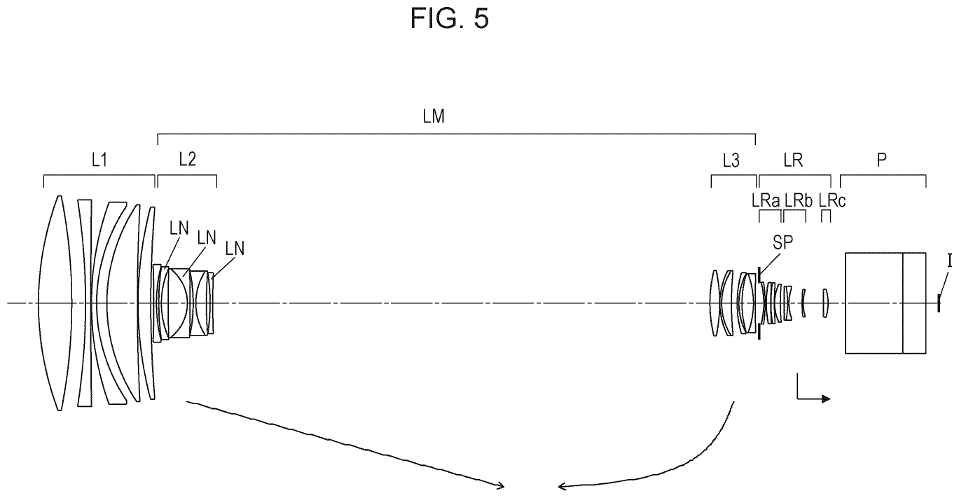

FIG. 5 is a cross-sectional view of a zoom lens according to a third embodiment at the wide-angle end in focusing on an object at infinity. The components of the zoom lens will be described in order from the object side to the image side with reference to FIG. 5. Reference sign L1 denotes a first lens unit having positive refractive power, which does not move for zooming.

Reference LM denotes an intermediate group including a plurality of lens units, which moves in zooming. Reference sign L2 in the intermediate group LM denotes a second lens unit having negative refractive power, which moves in zooming. Reference sign L3 in the intermediate group LM denotes a third lens unit having positive refractive power, which moves in zooming. The second lens unit L2 moves monotonically to the image side in zooming from the wide-angle end to the telephoto end. The third lens unit L3 moves monotonically to the object side in zooming from the wide-angle end to the telephoto end. Reference sign SP denotes an aperture stop, which does not move for zooming. Reference sign LR denotes a rear lens unit having positive refractive power, which does not move for zooming. A first sub-lens unit LRa in the rear lens unit LR does not move for focusing. A second sub-lens unit LRb in the rear lens unit LR moves to the image side for focusing from an object at infinity to an object at a close range. A third sub-lens unit LRc in the rear lens unit LR does not move for focusing.

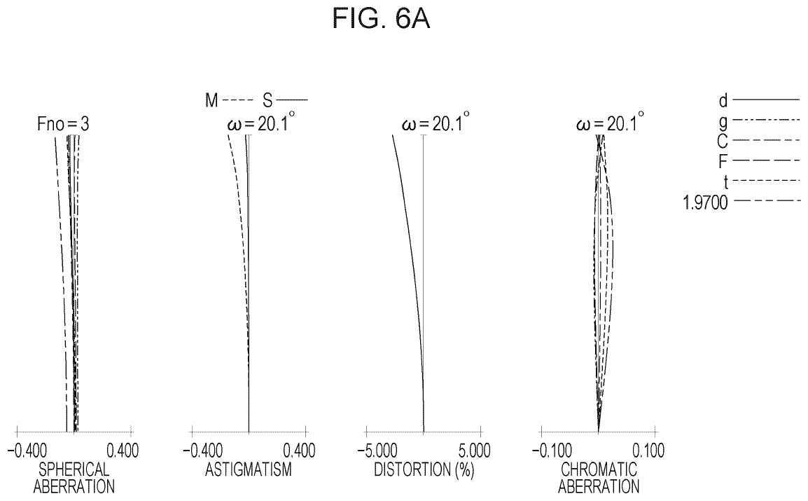

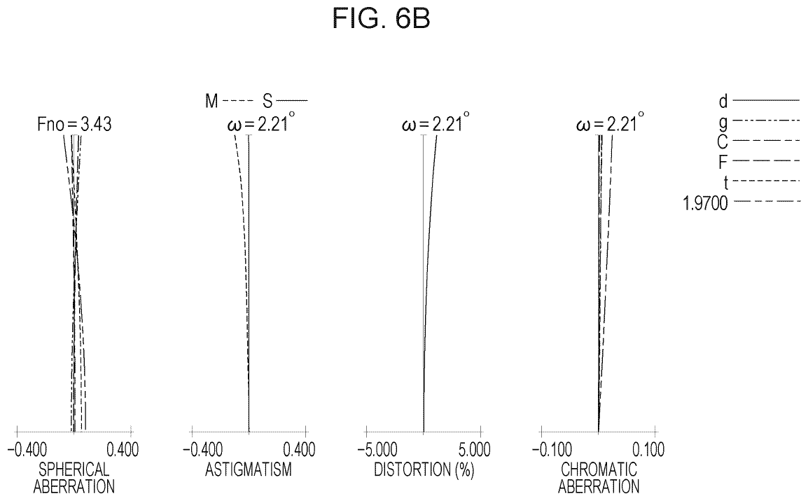

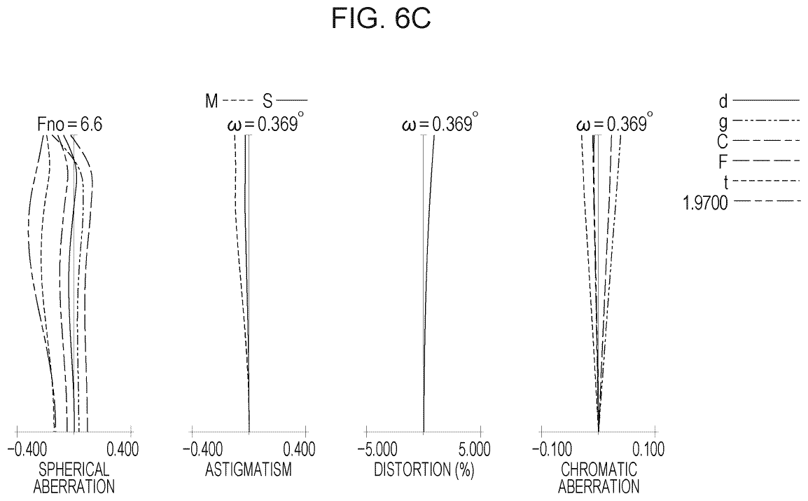

The first lens unit L1 has first to 10th surfaces and consists of three positive lenses and two negative lenses. The second lens unit L2 has 11th to 22nd surfaces and consists of two positive lens and five negative lenses. The third lens unit L3 has 23rd to 32nd surfaces and consists of three positive lenses and three negative lenses. The aperture stop SP has a 33rd surface. The rear lens unit LR has 34th to 48th surfaces. The first sub-lens unit LRa has 34th to 41st surfaces and consists of three positive lenses and one negative lenses. The second sub-lens unit LRb has 42nd to 46th surfaces and consists of one positive lenses and two negative lenses. The third sub-lens unit LRc has 47th and 48th surfaces and consists of one positive lens. FIGS. 6A to 6C are aberration charts in focusing on an object at infinity at a wide-angle end, at an intermediate point, and a telephoto end, respectively (their respective focal lengths are shown in Numerical Example 3). Its explanatory note is the same as that described with reference to FIGS. 2A to 2C.

In this embodiment, the negative lenses LN are the lens having the 13th and 14th surfaces in the second lens unit L2, the lens having the 16th and 17th surfaces in the second lens unit L2, and the lens having the 21st and 22nd surfaces in the second lens unit L2. In this embodiment, a lens unit having the strongest negative refractive power in the intermediate group LM is the second lens unit L2. In this embodiment, the negative lens LNm having the strongest negative refractive power in the negative lenses LN is the lens having the 16th and 17th surfaces in the second lens unit L2. In this embodiment, the sub-intermediate unit V is the second lens unit L2.

The values in Inequalities (1) to (18) of this embodiment are shown in Table 1. The values of the variables in Inequalities (1) to (18) are shown in Table 2. This embodiment provides a zoom lens that satisfies all of Inequalities (1) to (18) and is therefore advantageous in achieving high optical performance in a wavelength band from visible light to SWIR light and compact size. The zoom lens is provided by satisfying Inequalities (1) to (3) and does not necessarily have to satisfy Inequalities (4) to (18). If at least any one of Inequalities (4) to (18), in addition to Inequalities (1) to (3), is satisfied, a more prominent effect or an effect of a different nature is provided than otherwise. The advantageous effects provided when the inequalities are satisfied are described above.

### Fourth Embodiment

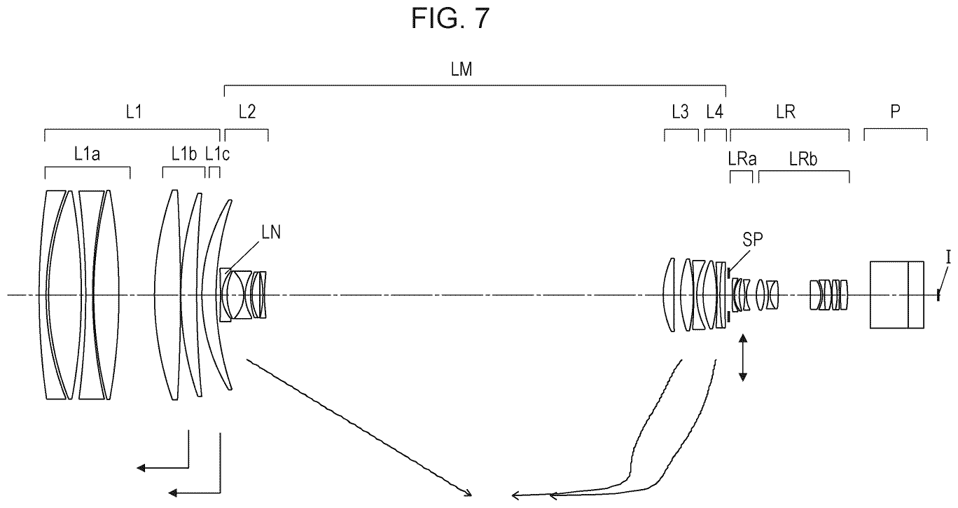

FIG. 7 is a cross-sectional view of a zoom lens according to a fourth embodiment at the wide-angle end in focusing on an object at infinity. The components of the zoom lens will be described in order from the object side to the image side with reference to FIG. 7. Reference sign L1 denotes a first lens unit having positive refractive power, which does not move for zooming. A first sub-lens unit L1a in the first lens unit L1 does not move for focusing. A second sub-lens unit L1b in the first lens unit L1 moves to the object side for focusing from an object at infinity to an object at a close range. A third sub-lens unit L1c in the first lens unit L1 moves to the object side on a trajectory different from the second sub-lens unit L1b for focusing from an object at infinity to an object at a close range. Reference LM denotes an intermediate group including a plurality of lens units, which moves in zooming. Reference sign L2 in the intermediate group LM denotes a second lens unit having negative refractive power, which moves in zooming, L3 in the intermediate group LM denotes a third lens unit having positive refractive power, which moves in zooming, and L4 in the intermediate group LM denotes a fourth lens unit having positive refractive power, which moves in zooming. The second lens unit L2 moves monotonically to the image side in zooming from the wide-angle end to the telephoto end. The third lens unit L3 moves (non-monotonically as shown) in the zooming. The fourth lens unit L4 moves (non-monotonically as shown) to the object side in the zooming. Reference sign SP denotes an aperture stop, which does not move for zooming. Reference sign LR denotes a rear lens unit having positive refractive power, which does not move for zooming. A first sub-lens unit LRa in the rear lens unit LR moves for stabilization of images at the amount of movement having a component in the direction perpendicular to the optical axis. A second sub-lens unit LRb in the rear lens unit LR does not move for stabilization of images.

The first lens unit L1 has first to 14th surfaces. The first sub-lens unit L1a has first to eighth surfaces and consists of two negative lenses and two positive lenses. The second sub-lens unit L1b has ninth to 12th surfaces and consists of two positive lenses. The third sub-lens unit L1c has 13th and 14th surfaces and consists of one positive lens. The second lens unit L2 has 15th to 24th surfaces and consists of one negative lens having an aspherical surface on the image side, two positive lenses, and two negative lenses. The third lens unit L3 has 25th to 30th surfaces and consists of one positive lens having an aspherical surface at the image side, one positive lens, and one negative lens. The fourth lens unit L4 has 31st to 35th surfaces and consists of one positive lens having an aspherical surface on the image side, one positive lens, and one negative lens. The aperture stop SP has a 36th surface. The rear lens unit LR has 37th to 57th surfaces.

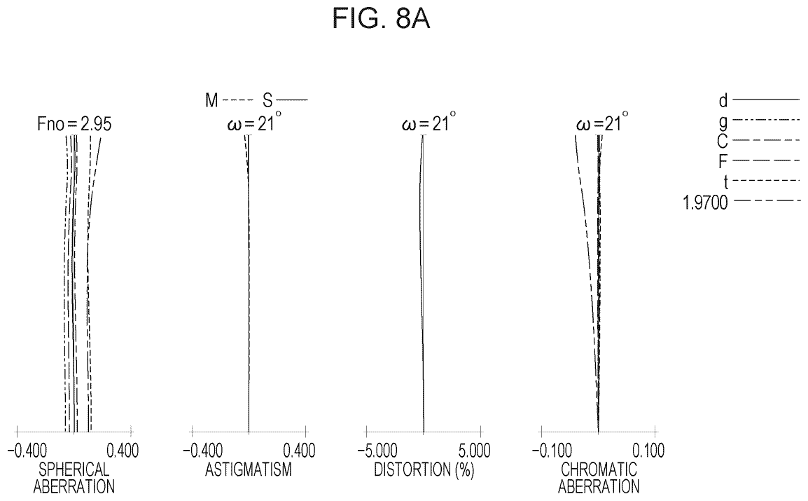

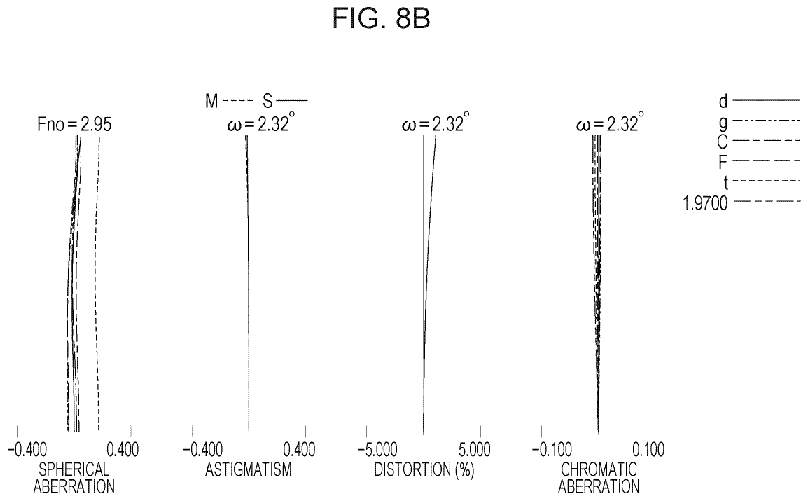

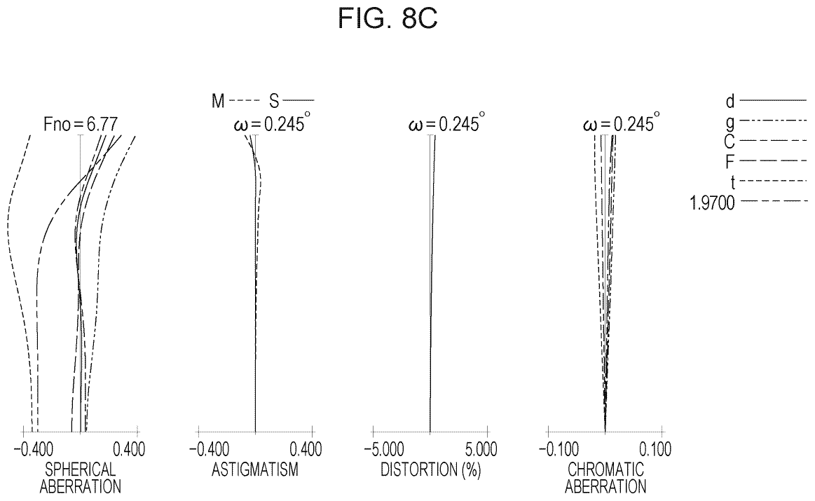

The first sub-lens unit LRa has 37th to 42nd surfaces and consists of one positive lens and two negative lenses. The second sub-lens unit LRb has 43rd to 57th surfaces and consists of six positive lenses and three negative lenses. FIGS. 8A to 8C are aberration charts in focusing on an object at infinity at a wide-angle end, at an intermediate point, and a telephoto end, respectively (their respective focal lengths are shown in Numerical Example 4). Its explanatory note is the same as that described with reference to FIGS. 2A to 2C.

In this embodiment, the negative lens LN is the lens having the 15th and 16th surfaces in the second lens unit L2. In this embodiment, a lens unit having the strongest negative refractive power in the intermediate group LM is the second lens unit L2. In this embodiment, the negative lens LNm having the strongest negative refractive power in the negative lenses LN is the lens having the 15th and 16th surfaces in the second lens unit L2. In this embodiment, the sub-intermediate unit V is the second lens unit L2.

The values in Inequalities (1) to (18) of this embodiment are shown in Table 1. The values of the variables in Inequalities (1) to (18) are shown in Table 2. This embodiment provides a zoom lens that satisfies all of Inequalities (1) to (18) and is therefore advantageous in achieving high optical performance in a wavelength band from visible light to SWIR light and compact size. The zoom lens is provided by satisfying Inequalities (1) to (3) and does not necessarily have to satisfy Inequalities (4) to (18). If at least any one of Inequalities (4) to (18), in addition to Inequalities (1) to (3), is satisfied, a more prominent effect or an effect of a different nature is provided than otherwise. The advantageous effects provided when the inequalities are satisfied are described above.

### Fifth Embodiment

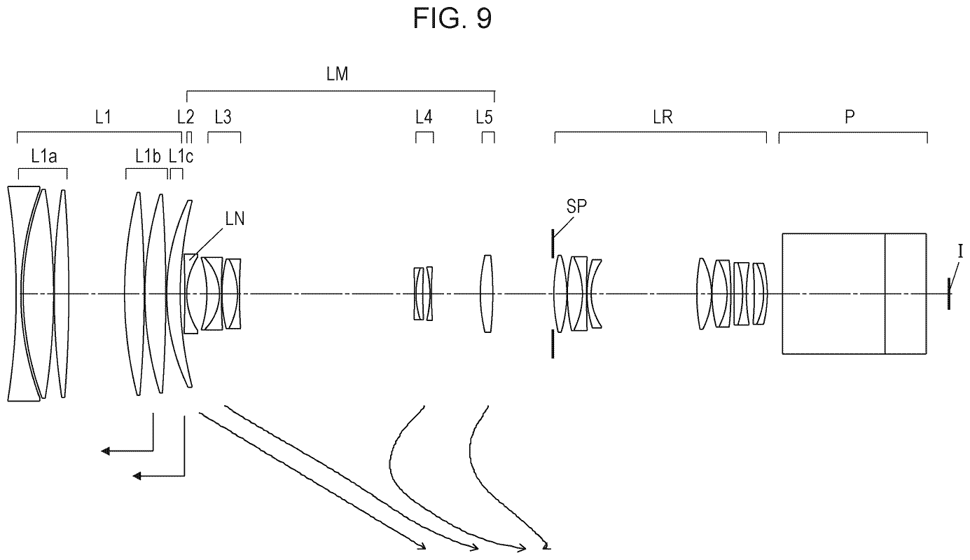

FIG. 9 is a cross-sectional view of a zoom lens according to a fifth embodiment at the wide-angle end in focusing on an object at infinity. The components of the zoom lens will be described in order from the object side to the image side with reference to FIG. 9. Reference sign L1 denotes a first lens unit having positive refractive power, which does not move for zooming. A first sub-lens unit L1a in the first lens unit L1 does not move for focusing. A second sub-lens unit L1b in the first lens unit L1 moves to the object side for focusing from an object at infinity to an object at a close range. A third sub-lens unit L1c in the first lens unit L1 moves to the object side on a trajectory different from the second sub-lens unit L1b for focusing from an object at infinity to an object at a close range. Reference LM denotes an intermediate group including a plurality of lens units, which moves in zooming. The intermediate group LM consists of second to fifth lens units L2 to L5. The second lens unit L2 has negative refractive power and moves in zooming. The third lens unit L3 has negative refractive power and moves in zooming. The fourth lens unit L4 has negative refractive power and moves in zooming. The fifth lens unit L5 has positive refractive power and moves in zooming. The second lens unit L2 moves monotonically to the image side in zooming from the wide-angle end to the telephoto end. The third lens unit L3 moves monotonically to the image side on a trajectory different from the second lens unit L2 in the focusing. The fourth lens unit L4 moves first to the object side and then to the image side in the zooming. The fifth lens unit L5 moves (non-monotonically as shown) in the zooming. Reference sign SP denotes an aperture stop, which does not move for zooming. Reference sign LR denotes a rear lens unit having positive refractive power, which does not move for zooming.

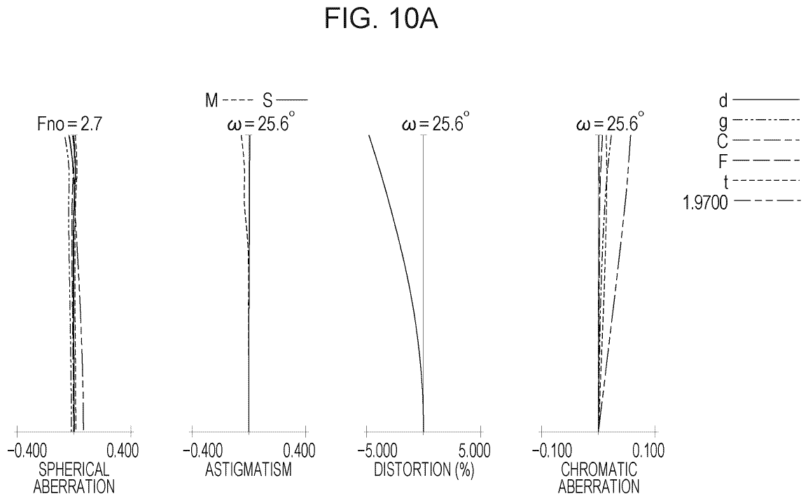

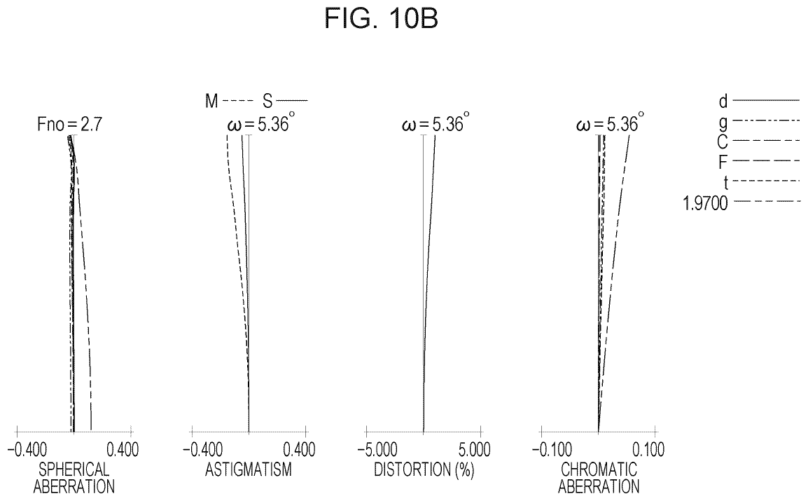

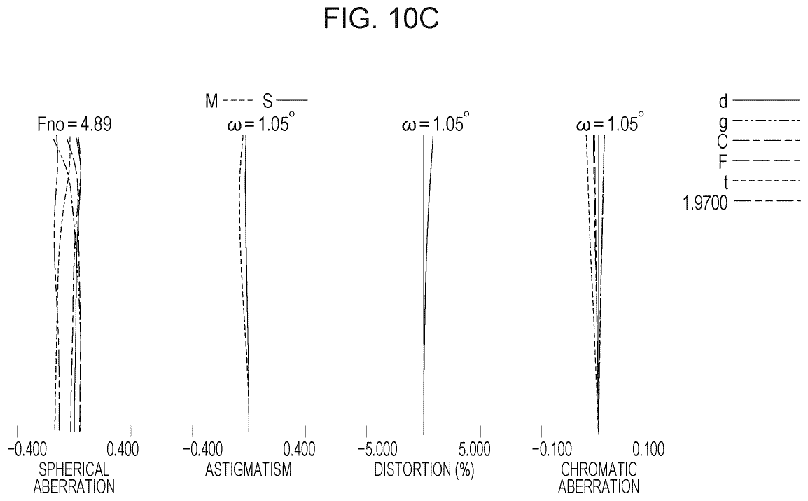

The first lens unit L1 has first to 12th surfaces. The first sub-lens unit L1a has first to sixth surfaces and consists of one negative lenses and two positive lenses. The second sub-lens unit L1b has seventh to 10th surfaces and consists of two positive lenses. The third sub-lens unit L1c has 11th and 12th surfaces and consists of one positive lens. The second lens unit L2 has 13th and 14th surfaces and consists of one negative lens having an aspherical surface on the object side. The third lens unit L3 has 15th to 20th surfaces and consists of two positive lenses and two negative lenses. The fourth lens unit L4 has 21st to 25th surfaces and consists of one positive lens and two negative lenses. The fifth lens unit L5 has 26th and 27th surfaces and consists of one positive lens having an aspherical surface on the object side. The aperture stop SP has a 28th surface. The rear lens unit LR has 29th to 46th surfaces and consists of five negative lenses and six positive lenses. FIGS. 10A to 10C are aberration charts in focusing on an object at infinity at a wide-angle end, at an intermediate point, and a telephoto end, respectively (their respective focal lengths are shown in Numerical Example 5). Its explanatory note is the same as that described with reference to FIGS. 2A to 2C.

In this embodiment, the negative lens LN is the lens having the 13th and 14th surfaces in the second lens unit L2. In this embodiment, a lens unit having the strongest negative refractive power in the intermediate group LM is the second lens unit L2. In this embodiment, the negative lens LNm having the strongest negative refractive power in the negative lenses LN is the lens having the 13th and 14th surfaces in the second lens unit L2. In this embodiment, the sub-intermediate unit V includes the second lens unit L2 and the third lens unit L3.

The values in Inequalities (1) to (18) of this embodiment are shown in Table 1. The values of the variables in Inequalities (1) to (18) are shown in Table 2. The sign “−” in Table 1 and Table 2 represents absence of values concerned. This embodiment provides a zoom lens that satisfies Inequalities (1) to (6), Inequality (9), Inequality (10), and Inequalities (13) to (18) and is therefore advantageous in achieving high optical performance in a wavelength band from visible light to SWIR light and compact size. The zoom lens is provided by satisfying Inequalities (1) to (3) and does not necessarily have to satisfy Inequalities (4) to (6), Inequality (9), Inequality (10), and Inequalities (13) to (18). If at least any one of Inequalities (4) to (6), Inequality (9), Inequality (10), and Inequalities (13) to (18), in addition to Inequalities (1) to (3), is satisfied, a more prominent effect or an effect of a different nature is provided than otherwise. The advantageous effects provided when the inequalities are satisfied are described above.

### Sixth Embodiment

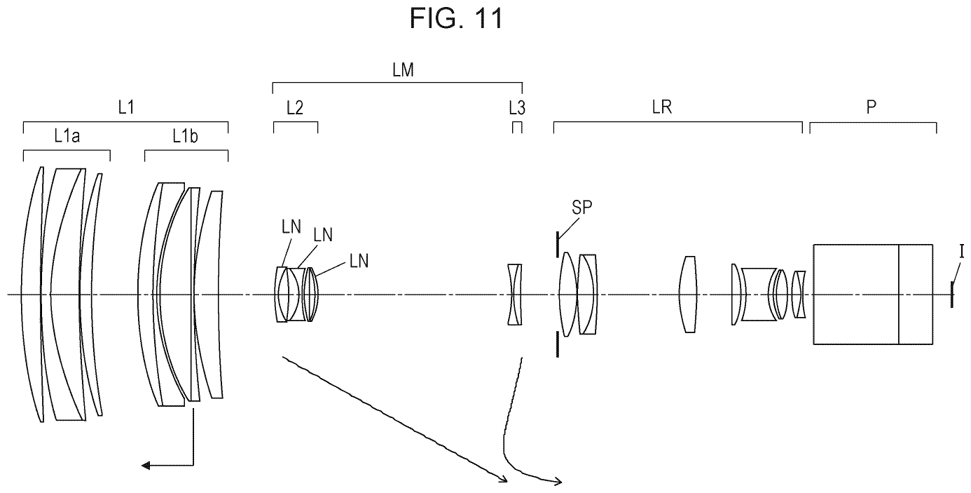

FIG. 11 is a cross-sectional view of a zoom lens according to a sixth embodiment at the wide-angle end in focusing on an object at infinity. The components of the zoom lens will be described in order from the object side to the image side with reference to FIG. 11. Reference sign L1 denotes a first lens unit having positive refractive power, which does not move for zooming. A first sub-lens unit L1a in the first lens unit L1 does not move for focusing. A second sub-lens unit L1b in the first lens unit L1 moves to the object side for focusing from an object at infinity to an object at a close range. Reference LM denotes an intermediate group including a plurality of lens units, which moves in zooming. Reference sign L2 in the intermediate group LM denotes a second lens unit having negative refractive power, which moves in zooming, and L3 in the intermediate group LM denotes a third lens unit having negative refractive power, which moves in zooming. The second lens unit L2 moves monotonically to the image side in zooming from the wide-angle end to the telephoto end. The third lens unit L3 moves first to the object side and then to the image side in the focusing. Reference sign SP denotes an aperture stop, which does not move for zooming. Reference sign LR denotes a rear lens unit having positive refractive power, which does not move for zooming.

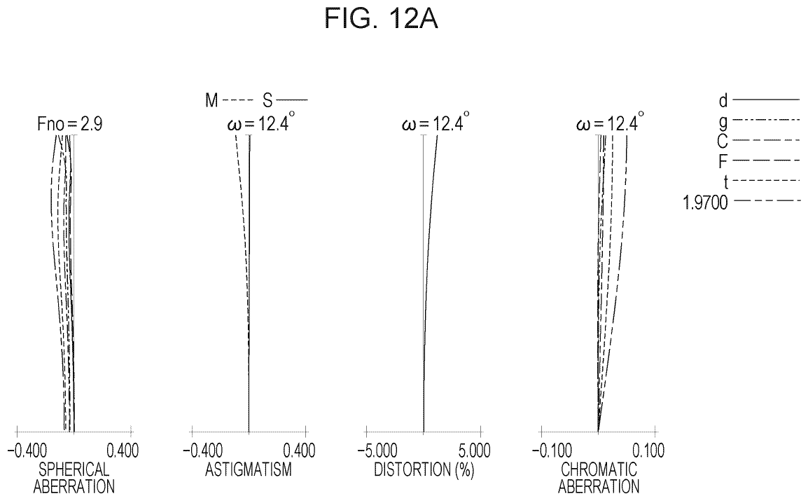

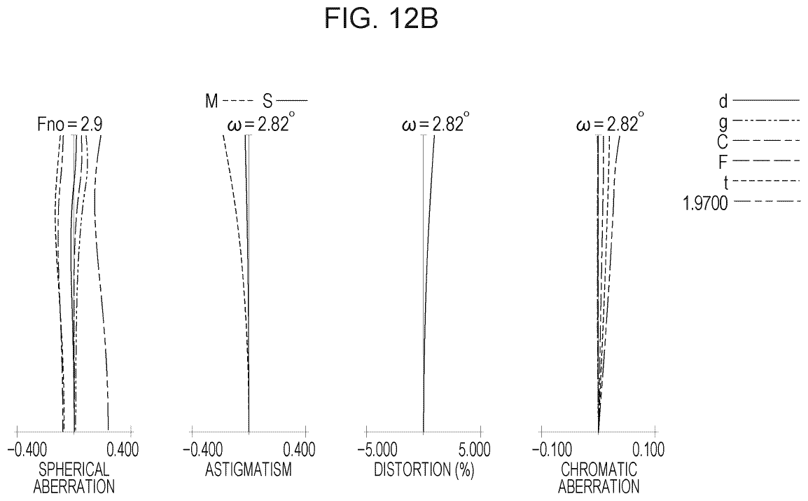

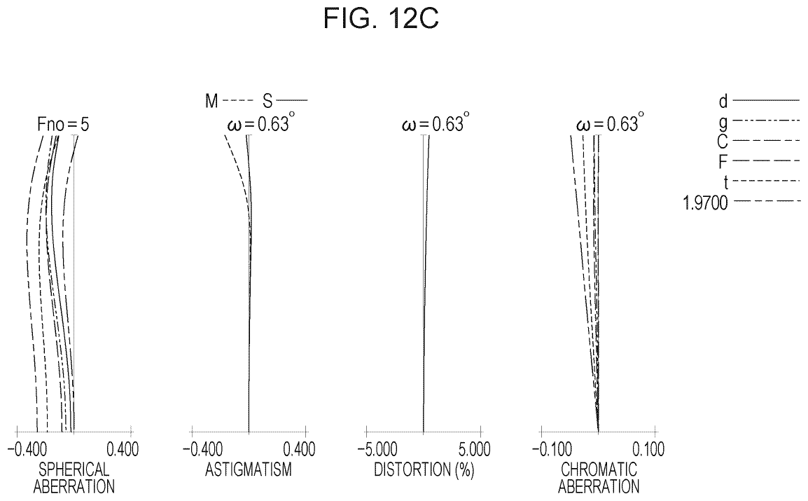

The first lens unit L1 has first to 15th surfaces. The first sub-lens unit L1a has first to seventh surfaces and consists of one negative lens and three positive lenses. The second sub-lens unit L1b has eighth to 15th surfaces and consists of two negative lenses and three positive lenses. The intermediate group LM consists of a second lens unit L2 and a third lens unit L3. The second lens unit L2 has 16th to 24th surfaces and consists of three negative lenses and two positive lenses. The third lens unit L3 has 25th to 27th surfaces and consists of one negative lens and one positive lens. The aperture stop SP has a 28th surface. The rear lens unit LR has 29th to 45th surfaces and consists of one positive lens having an aspherical surface at the image side, three negative lenses, and six positive lenses. FIGS. 12A to 12C are aberration charts in focusing on an object at infinity at a wide-angle end, at an intermediate point, and a telephoto end, respectively (their respective focal lengths are shown in Numerical Example 6). Its explanatory note is the same as that described with reference to FIGS. 2A to 2C.

In this embodiment, the negative lenses LN include the lens having the 16th and 17th surfaces in the second lens unit L2, the lens having the 19th and 20th surfaces in the second lens unit L2, and the lens having the 23rd and 24th surfaces in the second lens unit L2. In this embodiment, a lens unit having the strongest negative refractive power in the intermediate group LM is the second lens unit L2. In this embodiment, the negative lens LNm having the strongest negative refractive power in the negative lenses LN is the lens having the 19th and 20th surfaces in the second lens unit L2. In this embodiment, the sub-intermediate unit V is the second lens unit L2.

The values in Inequalities (1) to (18) of this embodiment are shown in Table 1. The values of the variables in Inequalities (1) to (18) are shown in Table 2. This embodiment provides a zoom lens that satisfies all of Inequalities (1) to (18) and is therefore advantageous in achieving high optical performance in a wavelength band from visible light to SWIR light and compact size. The zoom lens is provided by satisfying Inequalities (1) to (3) and does not necessarily have to satisfy Inequalities (4) to (18). If at least any one of Inequalities (4) to (18), in addition to Inequalities (1) to (3), is satisfied, a more prominent effect or an effect of a different nature is provided than otherwise. The advantageous effects provided when the inequalities are satisfied are described above.

### Seventh Embodiment

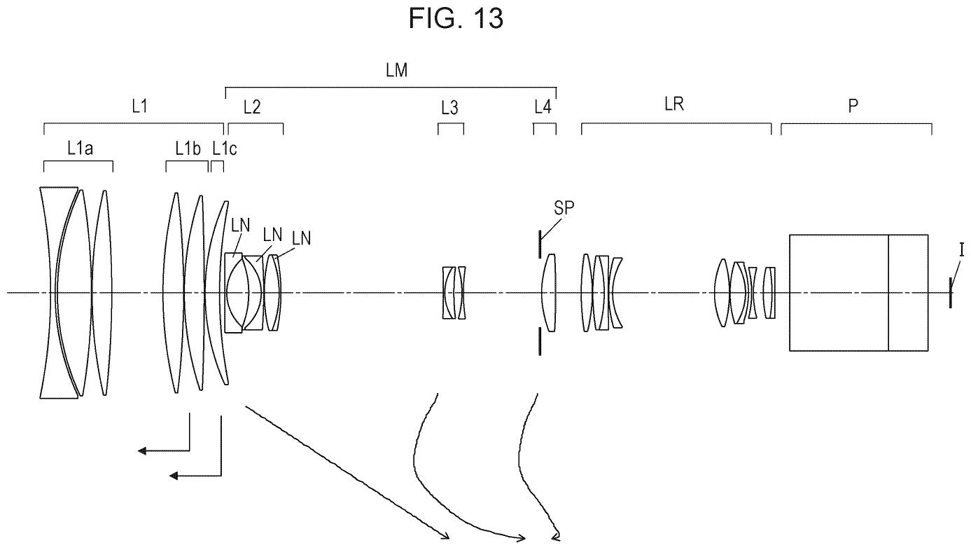

FIG. 13 is a cross-sectional view of a zoom lens according to a seventh embodiment at the wide-angle end in focusing on an object at infinity. The components of the zoom lens will be described in order from the object side to the image side with reference to FIG. 13. Reference sign L1 denotes a first lens unit having positive refractive power, which does not move for zooming. A first sub-lens unit L1a in the first lens unit L1 does not move for focusing. A second sub-lens unit L1b in the first lens unit L1 moves to the object side for focusing from an object at infinity to an object at a close range. A third sub-lens unit L1c in the first lens unit L1 moves to the object side on a trajectory different from the second sub-lens unit L1b for focusing from an object at infinity to an object at a close range.

Reference LM denotes an intermediate group including a plurality of lens units, which moves in zooming. Reference sign L2 in the intermediate group LM denotes a second lens unit having negative refractive power, which moves in zooming, L3 in the intermediate group LM denotes a third lens unit having negative refractive power, which moves in zooming, and L4 in the intermediate group LM denotes a fourth lens unit having positive refractive power, which moves in zooming. The second lens unit L2 moves monotonically to the image side in zooming from the wide-angle end to the telephoto end. The third lens unit L3 moves first to the image side and then to the object side in the zooming. The fourth lens unit L4 moves (non-monotonically a show) in the zooming. Reference sign SP denotes an aperture stop, which moves together with the fourth lens unit L4 in zooming. Reference sign LR denotes a rear lens unit having positive refractive power, which does not move for zooming.

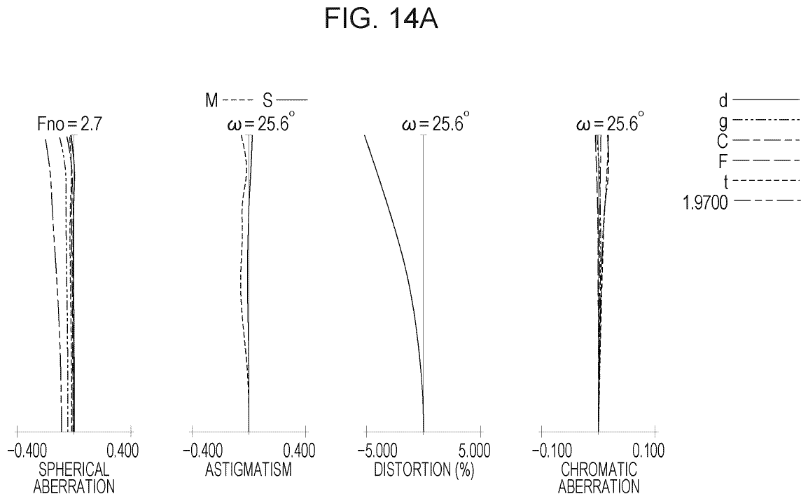

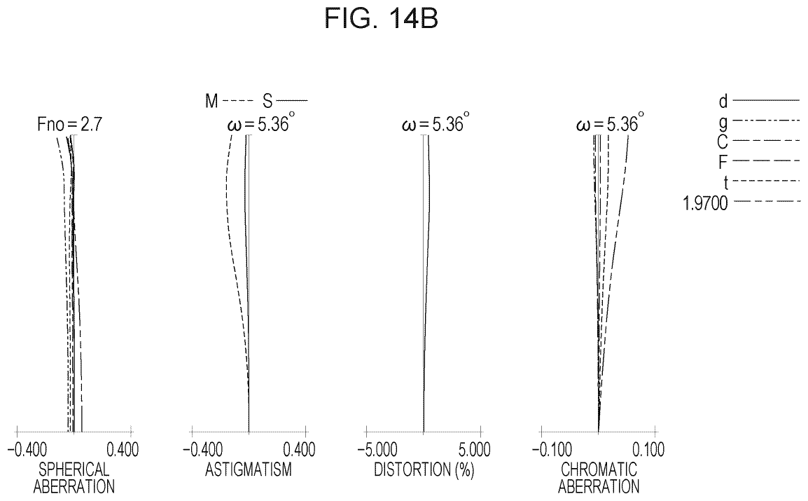

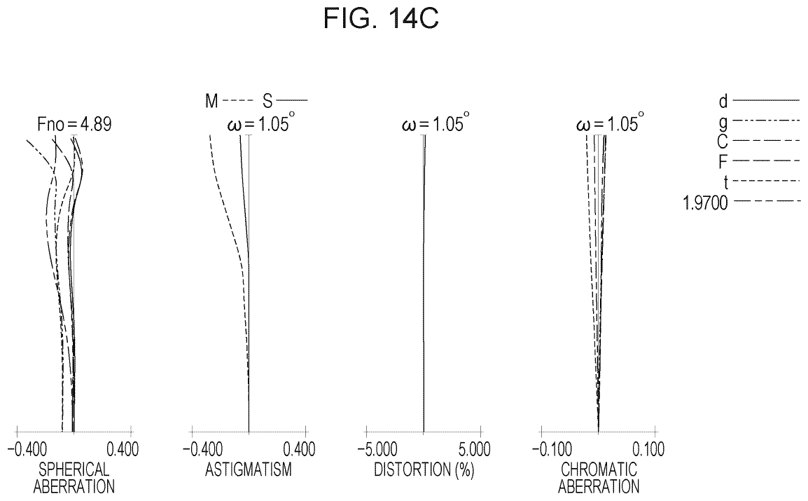

The first lens unit L1 has first to 12th surfaces. The first sub-lens unit L1a has first to sixth surfaces and consists of one negative lens and two positive lenses. The second sub-lens unit L1b has seventh to 10th surfaces and consists of two positive lenses. The third sub-lens unit L1c has 11th and 12th surfaces and consists of one positive lens. The second lens unit L2 has 13th to 20th surfaces and consists of one negative lens having an aspherical surface on the object side, two positive lenses, and two negative lenses. The third lens unit L3 has 21st to 25th surfaces and consists of one positive lens and two negative lenses. The aperture stop SP has a 26th surface. The fourth lens unit L4 has 27th and 28th surfaces and consists of one positive lens having an aspherical surface on the object side. The rear lens unit LR has 29th to 45th surfaces and consists of five negative lenses and five positive lenses. FIGS. 14A to 14C are aberration charts in focusing on an object at infinity at a wide-angle end, at an intermediate point, and a telephoto end, respectively (their respective focal lengths are shown in Numerical Example 7). Its explanatory note is the same as that described with reference to FIGS. 2A to 2C.

In this embodiment, the negative lenses LN are the lens having the 13th and 14th surfaces in the second lens unit L2, the lens having the 16th and 17th surfaces in the second lens unit L2, and the lens having the 19th and 20th surfaces in the second lens unit L2. In this embodiment, a lens unit having the strongest negative refractive power in the intermediate group LM is the second lens unit L2. In this embodiment, the negative lens LNm having the strongest negative refractive power in the negative lenses LN is the lens having the 13th and 14th surfaces in the second lens unit L2. In this embodiment, the sub-intermediate unit V is the second lens unit L2.

The values in Inequalities (1) to (18) of this embodiment are shown in Table 1. The values of the variables in Inequalities (1) to (18) are shown in Table 2. This embodiment provides a zoom lens that satisfies all of Inequalities (1) to (18) and is therefore advantageous in achieving high optical performance in a wavelength band from visible light to SWIR light and compact size. The zoom lens is provided by satisfying Inequalities (1) to (3) and does not necessarily have to satisfy Inequalities (4) to (18). If at least any one of Inequalities (4) to (18), in addition to Inequalities (1) to (3), is satisfied, a more prominent effect or an effect of a different nature is provided than otherwise. The advantageous effects provided when the inequalities are satisfied are described above.

In the first to seventh embodiments, the rear lens unit LR or part (a sub-lens unit) thereof is not moved except for focusing (changing the object distance) but may be moved except for focusing. This also provides the above-described advantageous effects. Such a change is easy for those skilled in the art. For example, in the first embodiment, a sub-lens having any of 36th to 47th surfaces in the rear lens unit LR may be moved. The 36th surface receives nearly afocal beam from the object side. For this reason, even if the sub-lens moves, optical characteristics other than the backfocus are generally unchanged. Thus, the movement allows correction of a change in focus due to a change in the state of the zoom lens regarding zooming, focusing, aperture stop, temperature, atmospheric pressure, orientation, insertion and extraction of the zooming optical system, or the like.

The following are numerical examples. The details of the numerical values in the individual numerical examples are as follows. In the numerical examples, r denotes the curvature radius of each surface, d denotes the interval between the surfaces, nd denotes the absolute refractive index of Fraunhofer line for d-line at 1 atmospheric pressure, and vd denotes Abbe number for d-line (with reference to d-line). “Half angle of view” w is expressed as w=arctan(Y/fw), where Y is one half of the diagonal image size of a camera including the zoom lens, and fw is the focal length of the zoom lens at the wide-angle end. “Maximum image height” corresponds to one half Y (for example, 5.50 mm) of the diagonal image size 2Y (for example, 11.00 mm). BF denotes backfocus (a length in free space). The last three surfaces are the surfaces of the glass block including a filter of the camera. Abbe number vd for d-line and a partial dispersion ratio θCt for C-line and t-line are expressed as:

vd=(nd−1)/(nF−nC)

θCt=(nC−nt)/(nF−nC)

where nF, nd, nC, and nt are respective refractive indices of Fraunhofer lines for F-line, d-line, C-line, and t-line. These definitions are the same as those in common use.

The shape of the aspherical surface (the amount of shift from the reference spherical surface) is expressed as follows, with the optical axis on the X-axis, the direction perpendicular to the optical axis on the H-axis, and the direction of travel of light as positive:

$$X + \frac{{H}^{2} / R}{1 + \sqrt{1 - ( 1 + k ) {( H / R )}^{2}}} + A 4 {H}^{4} + A 6 {H}^{6} + A 8 {H}^{8} + A 10 {H}^{10} + A 12 {H}^{12} + A 14 {H}^{14} + A 16 {H}^{16} + A 3 {H}^{3} + A 5 {H}^{5} + A 7 {H}^{7} + A 9 {H}^{9} + A 11 {H}^{11} + A 13 {H}^{13} + A 15 {H}^{15}$$

where R is the radius of paraxial curvature, k is the conic constant, A3 to A16 are aspherical surface coefficients.

In the numerical examples, sign “e-Z” represents “×10^{-Z}”, and sign “*” on the right of surface number indicates that the surface is an aspherical surface.

### NUMERICAL EXAMPLE 1

in mm
Surface Data

| Surface | | | | | |
|---|---|---|---|---|---|
| number | r | d | nd | vd | θct |
| 1 | 149.055 | 10.71 | 1.48749 | 70.2 | 0.8924 |
| 2 | −16894.196 | 0.19 | | | |
| 3 | 282.981 | 4.00 | 1.69680 | 55.5 | 0.8330 |
| 4 | 92.069 | 12.11 | 1.43875 | 94.9 | 0.8373 |
| 5 | 407.576 | 0.14 | | | |
| 6 | 183.529 | 4.70 | 1.43387 | 95.1 | 0.8092 |
| 7 | 329.164 | 17.08 | | | |
| 8 | 178.056 | 10.07 | 1.43875 | 94.9 | 0.8373 |
| 9 | −327.739 | 1.40 | 1.75500 | 52.3 | 0.8092 |
| 10 | 328.276 | 0.15 | | | |
| 11 | 155.233 | 8.36 | 1.43875 | 94.9 | 0.8373 |
| 12 | −837.452 | 1.40 | 1.64000 | 60.1 | 0.8645 |
| 13 | 318.431 | 2.19 | | | |
| 14 | 149.307 | 9.34 | 1.59522 | 67.7 | 0.7953 |
| 15 | 14023.753 | (variable) | | | |
| 16 | 102.708 | 0.90 | 1.75106 | 43.1 | 0.7097 |
| 17 | 22.063 | 4.08 | | | |
| 18 | −892.708 | 5.35 | 1.73800 | 32.3 | 0.7154 |
| 19 | −19.085 | 0.80 | 1.69930 | 51.1 | 0.7593 |
| 20 | 44.172 | 0.50 | | | |
| 21 | 29.227 | 3.07 | 1.67300 | 38.3 | 0.7481 |
| 22 | 185.970 | 1.96 | | | |
| 23 | −37.284 | 0.80 | 1.59522 | 67.7 | 0.7953 |
| 24 | −140.963 | (variable) | | | |
| 25 | −43.847 | 0.80 | 1.71700 | 47.9 | 0.7629 |
| 26 | 39.590 | 2.52 | 1.84666 | 23.8 | 0.6614 |
| 27 | 200.341 | (variable) | | | |
| 28 | (aperture) | ∞ | 0.50 | | |
| 29 | 57.569 | 7.40 | 1.59522 | 67.7 | 0.7953 |
| 30* | −47.593 | 0.09 | | | |
| 31 | 55.727 | 3.73 | 1.43875 | 94.7 | 0.8410 |
| 32 | −5550.259 | 0.11 | | | |
| 33 | 105.240 | 6.21 | 1.43875 | 94.7 | 0.8410 |
| 34 | −30.625 | 0.90 | 1.80610 | 40.9 | 0.7483 |
| 35 | 119.218 | 34.39 | | | |
| 36 | 62.288 | 2.84 | 1.43875 | 94.7 | 0.8410 |
| 37 | −329.012 | 0.18 | | | |
| 38 | 107.801 | 3.58 | 1.43875 | 94.7 | 0.8410 |
| 39 | −50.112 | 6.62 | | | |
| 40 | −234.311 | 0.80 | 1.65160 | 58.5 | 0.8525 |
| 41 | 12.128 | 3.87 | 1.60342 | 38.0 | 0.7353 |
| 42 | 18.638 | 0.84 | | | |
| 43 | 17.657 | 4.06 | 1.56732 | 42.8 | 0.7589 |
| 44 | −368.192 | 1.57 | | | |
| 45 | 44.805 | 3.60 | 1.54072 | 47.2 | 0.7766 |
| 46 | −24.930 | 0.80 | 1.85026 | 32.3 | 0.6942 |
| 47 | 77.632 | 5.00 | | | |
| 48 | ∞ | 33.00 | 1.60859 | 46.4 | 0.7534 |
| 49 | ∞ | 13.20 | 1.51680 | 64.2 | 0.8698 |
| 50 | ∞ | 7.40 | | | |
| Image | ∞ | | | | |
| plane | | | | | |

Aspherical Surface Data
30th surface
K= 0.00000e+00 A4 = 7.16035e−07 A6 = −3.49782e−10 A8 = −1.85840e−12
A10 = 1.52258e−15

Various Data

| | |
|---|---|
| Zoom ratio | 20.00 |

| | Wide−angle end | Intermediate point | Telephoto end |
|---|---|---|---|
| Focal length | 25.00 | 111.80 | 500.00 |
| F-number | 2.90 | 2.90 | 5.00 |
| Half angle of view | 12.41 | 2.82 | 0.63 |
| Image height | 5.50 | 5.50 | 5.50 |
| Entire lens length | 350.00 | 350.00 | 350.00 |
| BF | 7.40 | 7.40 | 7.40 |
| d15 | 8.95 | 68.36 | 93.17 |
| d24 | 76.04 | 11.02 | 11.57 |
| d27 | 21.70 | 27.31 | 1.95 |
| d50 | 7.40 | 7.40 | 7.40 |

Zoom Lens Unit Data

| Unit | Starting surface | Focal length |
|---|---|---|
| 1 | 1 | 163.84 |
| 2 | 16 | −28.11 |
| 3 | 25 | −57.52 |
| 4 | 29 | 40.69 |

### NUMERICAL EXAMPLE 2

in mm
Surface Data

| Surface | | | | | |
|---|---|---|---|---|---|
| number | r | d | nd | vd | θct |
| 1 | 205.860 | 3.00 | 1.75500 | 52.3 | 0.8092 |
| 2 | 141.110 | 3.38 | | | |
| 3 | 162.200 | 13.67 | 1.43387 | 95.1 | 0.8092 |
| 4 | −696.139 | 0.47 | | | |
| 5 | −8368.031 | 3.00 | 1.75500 | 52.3 | 0.8092 |
| 6 | 149.934 | 1.25 | | | |
| 7 | 143.299 | 12.75 | 1.43387 | 95.1 | 0.8092 |
| 8 | −24298.691 | 13.35 | | | |
| 9 | 179.863 | 8.89 | 1.43387 | 95.1 | 0.8092 |
| 10 | 1161.166 | 0.20 | | | |
| 11 | 164.642 | 11.77 | 1.43387 | 95.1 | 0.8092 |
| 12 | −1365.806 | 0.48 | | | |
| 13 | 114.265 | 6.27 | 1.43387 | 95.1 | 0.8092 |
| 14 | 181.786 | (variable) | | | |
| 15 | 176.724 | 1.40 | 1.69930 | 51.1 | 0.7593 |
| 16 | 35.603 | 1.89 | | | |
| 17 | 44.882 | 12.04 | 1.61310 | 44.4 | 0.8010 |
| 18 | −38.744 | 1.30 | 1.59522 | 67.7 | 0.7953 |
| 19 | 23.172 | 5.01 | | | |
| 20 | 53.667 | 1.30 | 1.63858 | 55.2 | 0.7865 |
| 21 | 30.893 | 6.45 | 1.67300 | 38.3 | 0.7481 |
| 22 | −112.312 | 2.91 | | | |
| 23 | −33.250 | 1.20 | 1.59522 | 67.7 | 0.7953 |
| 24* | 89.826 | (variable) | | | |
| 25 | −244.613 | 1.00 | 1.69930 | 51.1 | 0.7593 |
| 26 | 26.463 | 3.02 | 1.74951 | 35.3 | 0.7308 |
| 27 | 148.787 | 2.45 | | | |
| 28 | −41.792 | 1.00 | 1.59522 | 67.7 | 0.7953 |
| 29 | 442.162 | (variable) | | | |
| 30* | 52.312 | 6.45 | 1.59522 | 67.7 | 0.7953 |
| 31 | −83.486 | (variable) | | | |
| 32 (aperture) | ∞ | 0.30 | | | |
| 33 | 65.297 | 3.55 | 1.43875 | 94.9 | 0.8373 |
| 34 | −248.716 | 0.20 | | | |
| 35 | 176.843 | 5.81 | 1.43875 | 94.9 | 0.8373 |
| 36 | −43.462 | 1.30 | 1.64000 | 60.1 | 0.8645 |
| 37 | −134.169 | 0.20 | | | |
| 38 | 72.500 | 1.30 | 1.64000 | 60.1 | 0.8645 |
| 39 | 29.388 | 33.97 | | | |
| 40 | 21.422 | 7.08 | 1.43875 | 94.9 | 0.8373 |
| 41 | −52.222 | 0.20 | | | |
| 42 | 45.862 | 6.15 | 1.43875 | 94.9 | 0.8373 |
| 43 | −22.593 | 1.20 | 1.65160 | 58.5 | 0.8270 |
| 44 | 15.929 | 2.15 | | | |
| 45 | 22.421 | 4.13 | 1.51633 | 64.1 | 0.8687 |
| 46 | −34.989 | 1.20 | 2.00100 | 29.1 | 0.6838 |
| 47 | 42.073 | 7.53 | | | |
| 48 | 47.198 | 4.70 | 1.78472 | 25.7 | 0.6702 |
| 49 | −74.967 | 1.20 | 1.85920 | 33.0 | 0.6855 |
| 50 | −60.279 | 4.87 | | | |
| 51 | ∞ | 33.00 | 1.60859 | 46.4 | 0.7534 |
| 52 | ∞ | 13.20 | 1.51680 | 64.2 | 0.8698 |
| 53 | ∞ | 7.40 | | | |
| Image plane | ∞ | | | | |

Aspherical Surface Data
24th surface
K = 0.00000e+00 A4 = −1.39031e−05 A6 = 1.23886e−09 A8 = 9.99239e−11
A10 = −2.79043e−13 A12 = 5.26650e−16
A3 = 2.82395e−06 A5 = −7.46597e−09 A7 = −9.43023e−10
30th surface
K = −5.07198e+00 A4 = 9.50981e−07 A6 = −1.46718e−09 A8 = 4.78513e−13
A10 = 3.76242e−15 A12 = −6.56234e−18

Various Data
Zoom ratio 40.00

| | Wide-angle end | Intermediate point | Telephoto end |
|---|---|---|---|
| Focal length | 14.00 | 88.54 | 560.00 |
| F-number | 2.80 | 2.80 | 5.10 |
| Half angle of view | 21.45 | 3.55 | 0.56 |
| Image height | 5.50 | 5.50 | 5.50 |
| Entire lens length | 400.00 | 400.00 | 400.00 |
| BF | 7.40 | 7.40 | 7.40 |
| d14 | 1.68 | 87.59 | 114.17 |
| d24 | 90.41 | 11.68 | 8.79 |
| d29 | 26.15 | 31.09 | 1.94 |
| d31 | 15.22 | 3.10 | 8.55 |
| d53 | 7.40 | 7.40 | 7.40 |

Zoom Lens Unit Data

| Unit | Starting surface | Focal length |
|---|---|---|
| 1 | 1 | 167.49 |
| 2 | 15 | −27.85 |
| 3 | 25 | −45.66 |
| 4 | 30 | 55.01 |
| 5 | 33 | 83.75 |

### NUMERICAL EXAMPLE 3

in mm
Surface Data

| Surface | | | | | |
|---|---|---|---|---|---|
| number | r | d | nd | vd | θct |
| 1 | 200.145 | 19.16 | 1.43387 | 95.1 | 0.8092 |
| 2 | −363.568 | 7.89 | | | |
| 3 | −448.706 | 3.00 | 1.75500 | 52.3 | 0.8092 |
| 4 | 5218.354 | 0.40 | | | |
| 5 | 197.361 | 3.00 | 1.69680 | 55.5 | 0.8330 |
| 6 | 113.608 | 5.84 | | | |
| 7 | 116.289 | 17.57 | 1.43875 | 94.9 | 0.8373 |
| 8 | 1290.516 | 0.40 | | | |
| 9 | 249.182 | 7.29 | 1.43387 | 95.1 | 0.8092 |
| 10 | 753.244 | (variable) | | | |
| 11 | −625.144 | 1.50 | 1.59522 | 67.7 | 0.7953 |
| 12 | 99.991 | 1.33 | | | |
| 13 | 165.266 | 1.50 | 1.69930 | 51.1 | 0.7593 |
| 14 | 57.402 | 3.87 | | | |
| 15 | 661.966 | 11.10 | 1.74951 | 35.3 | 0.7308 |
| 16 | −28.033 | 1.50 | 1.75106 | 43.1 | 0.7097 |
| 17 | −724.442 | 1.81 | | | |
| 18 | −104.405 | 1.50 | 1.49700 | 81.5 | 0.8258 |
| 19 | 38.825 | 6.12 | 1.61340 | 44.3 | 0.7825 |
| 20 | 287.393 | 2.12 | | | |
| 21 | −129.866 | 1.50 | 1.69930 | 51.1 | 0.7593 |
| 22 | 524.710 | (variable) | | | |
| 23 | 87.668 | 5.61 | 1.43875 | 94.9 | 0.8373 |
| 24 | −106.108 | 0.15 | | | |
| 25 | 47.669 | 1.00 | 1.75500 | 52.3 | 0.8092 |
| 26 | 39.815 | 5.65 | 1.43875 | 94.9 | 0.8373 |
| 27 | 227.324 | 3.24 | | | |
| 28 | 71.788 | 1.00 | 1.75500 | 52.3 | 0.8092 |
| 29 | 41.978 | 1.82 | | | |
| 30 | 68.929 | 6.56 | 1.59522 | 67.7 | 0.7953 |
| 31 | −55.032 | 1.00 | 1.75500 | 52.3 | 0.8092 |
| 32 | 596.629 | (variable) | | | |
| 33 (aperture) | ∞ | 2.69 | | | |
| 34 | −58.820 | 0.80 | 1.69930 | 51.1 | 0.7593 |
| 35 | −103.684 | 0.67 | | | |
| 36 | 67.895 | 2.53 | 1.85478 | 24.8 | 0.6739 |
| 37 | 204.847 | 0.15 | | | |
| 38 | 98.539 | 2.00 | 1.43875 | 94.9 | 0.8373 |
| 39 | 181.733 | 0.15 | | | |
| 40 | 30.221 | 3.31 | 1.43875 | 94.9 | 0.8373 |
| 41 | 148.416 | 2.19 | | | |
| 42 | 721.103 | 1.93 | 1.83481 | 42.7 | 0.7533 |
| 43 | −65.197 | 0.75 | 1.73400 | 51.5 | 0.8067 |
| 44 | 29.158 | 7.59 | | | |
| 45 | 99.096 | 0.70 | 2.05090 | 26.9 | 0.6726 |
| 46 | 32.244 | 11.55 | | | |
| 47 | 972.991 | 2.66 | 1.72916 | 54.7 | 0.8244 |
| 48 | −32.990 | 10.00 | | | |
| 49 | ∞ | 33.00 | 1.60859 | 46.4 | 0.7534 |
| 50 | ∞ | 13.20 | 1.51633 | 64.2 | 0.8676 |
| 51 | ∞ | 7.40 | | | |
| Image plane | ∞ | | | | |

Various Data
Zoom ratio 57.00

| | Wide-angle end | Intermediate point | Telephoto end |
|---|---|---|---|
| Focal length | 15.00 | 142.30 | 855.00 |
| F-number | 3.00 | 3.43 | 6.60 |
| Half angle of view | 20.14 | 2.21 | 0.37 |
| Image height | 5.50 | 5.50 | 5.50 |
| Entire lens length | 517.40 | 517.40 | 517.40 |
| BF | 7.40 | 7.40 | 7.40 |
| d10 | 1.75 | 148.55 | 185.06 |
| d22 | 285.74 | 102.70 | 1.48 |
| d32 | 2.22 | 38.46 | 103.17 |
| d51 | 7.40 | 7.40 | 7.40 |

Zoom Lens Unit Data

| Unit | Starting surface | Focal length |
|---|---|---|
| 1 | 1 | 286.02 |
| 2 | 11 | −38.26 |
| 3 | 23 | 76.84 |
| 4 | 34 | 209.16 |

### NUMERICAL EXAMPLE 4

in mm
Surface Data

| Surface | | | | | |
|---|---|---|---|---|---|
| number | r | d | nd | vd | θct |
| 1 | 726.264 | 6.00 | 1.75500 | 52.3 | 0.8092 |
| 2 | 278.729 | 2.23 | | | |
| 3 | 277.824 | 28.23 | 1.43387 | 95.1 | 0.8092 |
| 4 | −573.275 | 3.81 | | | |
| 5 | −798.431 | 6.00 | 1.72916 | 54.7 | 0.8244 |
| 6 | 468.971 | 1.00 | | | |
| 7 | 419.612 | 21.72 | 1.43387 | 95.1 | 0.8092 |
| 8 | −598.982 | 30.81 | | | |
| 9 | 312.689 | 22.46 | 1.43387 | 95.1 | 0.8092 |
| 10 | −1808.073 | 0.25 | | | |
| 11 | 308.097 | 13.75 | 1.43387 | 95.1 | 0.8092 |
| 12 | 1020.309 | 4.52 | | | |
| 13 | 179.222 | 12.24 | 1.43875 | 94.7 | 0.8410 |
| 14 | 286.822 | (variable) | | | |
| 15 | −651.200 | 1.40 | 1.69930 | 51.1 | 0.7593 |
| 16 | 35.918 | 4.27 | | | |
| 17 | 55.389 | 14.46 | 1.61310 | 44.4 | 0.8010 |
| 18 | −32.695 | 1.30 | 1.59522 | 67.7 | 0.7953 |
| 19 | 40.943 | 4.57 | | | |
| 20 | 71.959 | 1.30 | 1.63858 | 55.2 | 0.7865 |
| 21 | 46.624 | 6.82 | 1.67300 | 38.3 | 0.7481 |
| 22 | −1545.600 | 2.59 | | | |
| 23 | −87.208 | 1.20 | 1.59522 | 67.7 | 0.7953 |
| 24* | 111.316 | (variable) | | | |
| 25 | 86.468 | 9.40 | 1.59522 | 67.7 | 0.7953 |
| 26* | −1557.577 | 5.64 | | | |
| 27 | 110.201 | 10.86 | 1.43875 | 94.9 | 0.8373 |
| 28 | −167.754 | 0.47 | | | |
| 29 | −537.418 | 2.60 | 1.61310 | 44.4 | 0.8010 |
| 30 | 69.114 | (variable) | | | |
| 31 | 84.887 | 11.56 | 1.43875 | 94.9 | 0.8373 |
| 32 | −142.382 | 0.50 | | | |
| 33 | −544.391 | 2.50 | 1.61310 | 44.4 | 0.8010 |
| 34 | 244.251 | 4.47 | 1.59522 | 67.7 | 0.7953 |
| 35* | ∞ | (variable) | | | |
| 36 (aperture) | ∞ | 3.16 | | | |
| 37 | 338.696 | 1.40 | 1.43875 | 94.9 | 0.8373 |
| 38 | 32.281 | 0.50 | | | |
| 39 | 24.995 | 4.24 | 1.61340 | 44.3 | 0.7825 |
| 40 | 53.451 | 4.69 | | | |
| 41 | −92.687 | 1.40 | 1.43875 | 94.9 | 0.8373 |
| 42 | 31.092 | 8.62 | | | |
| 43 | 36.989 | 6.98 | 1.43875 | 94.9 | 0.8373 |
| 44 | −42.288 | 3.44 | | | |
| 45 | −47.389 | 1.60 | 2.00100 | 29.1 | 0.6838 |
| 46 | 20.935 | 6.98 | 1.85478 | 24.8 | 0.6739 |
| 47 | −101.285 | 27.92 | | | |
| 48 | −4463.147 | 8.84 | 1.43875 | 94.9 | 0.8373 |
| 49 | −28.182 | 1.47 | | | |
| 50 | −29.887 | 1.80 | 1.64000 | 60.1 | 0.8645 |
| 51 | 125.196 | 5.88 | 1.59522 | 67.7 | 0.7953 |
| 52 | −49.014 | 0.60 | | | |
| 53 | 141.937 | 4.44 | 1.59551 | 39.2 | 0.7402 |
| 54 | −61.689 | 1.80 | 1.95375 | 32.3 | 0.6988 |
| 55 | −302.355 | 1.00 | | | |
| 56 | 207.498 | 6.17 | 1.43875 | 94.9 | 0.8373 |
| 57 | −103.658 | 19.65 | | | |
| 58 | ∞ | 33.00 | 1.60859 | 46.4 | 0.7534 |
| 59 | ∞ | 13.20 | 1.51633 | 64.2 | 0.8676 |
| 60 | ∞ | 13.29 | | | |
| Image plane | ∞ | | | | |

Aspherical Surface Data
24th surface
K = 1.47809e+01 A4 = −4.82145e−06 A6 = −1.63377e−09 A8 = −7.31291e−13
A10 = −1.04250e−15 A12 = −2.55286e−18
26th surface
K = 2.16390e+02 A4 = 3.40866e−07 A6 = −7.19151e−12 A8 = 1.66846e−14
A10 = −7.74881e−18 A12 = 2.37323e−21
35th surface
K = −9.69844e+12 A4 = 2.83089e−07 A6 = 1.13389e−10 A8 = −1.14330e−13
A10 = 1.18936e−16 A12 = −5.02120e−20

Various Data
Zoom ratio 90.00

| | Wide-angle end | Intermediate point | Telephoto end |
|---|---|---|---|
| Focal length | 14.30 | 135.66 | 1286.99 |
| F-number | 2.95 | 2.95 | 6.77 |
| Half angle of view | 21.04 | 2.32 | 0.24 |
| Image height | 5.50 | 5.50 | 5.50 |
| Entire lens length | 778.27 | 778.27 | 778.27 |
| BF | 13.29 | 13.29 | 13.29 |
| d14 | 3.81 | 159.26 | 199.11 |
| d24 | 345.01 | 145.23 | 2.00 |
| d30 | 5.50 | 7.31 | 9.23 |
| d35 | 2.96 | 45.47 | 146.93 |
| d60 | 13.29 | 13.29 | 13.29 |

Zoom Lens Unit Data

| Unit | Starting surface | Focal length |
|---|---|---|
| 1 | 1 | 282.68 |
| 2 | 15 | −34.71 |
| 3 | 25 | 201.69 |
| 4 | 31 | 143.30 |
| 5 | 37 | 84.86 |

### NUMERICAL EXAMPLE 5

in mm
Surface Data

| Surface | | | | | |
|---|---|---|---|---|---|
| number | r | d | nd | vd | θct |
| 1 | −252.130 | 1.50 | 1.75500 | 52.3 | 0.8092 |
| 2 | 109.669 | 0.76 | | | |
| 3 | 109.726 | 9.74 | 1.43387 | 95.1 | 0.8092 |
| 4 | −243.203 | 0.20 | | | |
| 5 | 262.783 | 4.73 | 1.43387 | 95.1 | 0.8092 |
| 6 | −473.152 | 17.92 | | | |
| 7 | 153.255 | 6.31 | 1.43387 | 95.1 | 0.8092 |
| 8 | −434.667 | 0.23 | | | |
| 9 | 124.421 | 6.72 | 1.43387 | 95.1 | 0.8092 |
| 10 | −530.710 | 0.29 | | | |
| 11 | 79.139 | 4.33 | 1.43387 | 95.1 | 0.8092 |
| 12 | 135.544 | (variable) | | | |
| 13* | −353.175 | 0.60 | 1.85920 | 33.0 | 0.6855 |
| 14 | 24.649 | (variable) | | | |
| 15 | −43.151 | 4.04 | 1.85478 | 24.8 | 0.6739 |
| 16 | −18.453 | 0.60 | 1.59522 | 67.7 | 0.7953 |
| 17 | 215.047 | 0.18 | | | |
| 18 | 52.294 | 5.02 | 1.61340 | 44.3 | 0.7825 |
| 19 | −27.308 | 0.60 | 1.81600 | 46.6 | 0.7690 |
| 20 | 179.155 | (variable) | | | |
| 21 | −331.471 | 0.50 | 1.59410 | 60.5 | 0.7800 |
| 22 | 29.451 | 2.17 | 1.74951 | 35.3 | 0.7308 |
| 23 | 151.446 | 2.32 | | | |
| 24 | −40.085 | 0.50 | 1.59522 | 67.7 | 0.7953 |
| 25 | 139.466 | (variable) | | | |
| 26* | 57.222 | 4.02 | 1.72916 | 54.7 | 0.8244 |
| 27 | −127.689 | (variable) | | | |
| 28 (aperture) | ∞ | 0.29 | | | |
| 29 | 63.811 | 4.14 | 1.43875 | 94.9 | 0.8373 |
| 30 | −49.740 | 0.20 | | | |
| 31 | 60.087 | 4.86 | 1.43875 | 94.9 | 0.8373 |
| 32 | −29.821 | 1.30 | 1.64000 | 60.1 | 0.8645 |
| 33 | 423.022 | 0.20 | | | |
| 34 | 41.370 | 1.30 | 1.64000 | 60.1 | 0.8645 |
| 35 | 20.883 | 33.97 | | | |
| 36 | 72.044 | 4.70 | 1.43875 | 94.9 | 0.8373 |
| 37 | −28.530 | 0.20 | | | |
| 38 | 48.419 | 4.86 | 1.43875 | 94.9 | 0.8373 |
| 39 | −26.006 | 1.20 | 1.65160 | 58.5 | 0.8525 |
| 40 | −118.676 | 1.04 | | | |
| 41 | 2087.084 | 2.74 | 1.67300 | 38.3 | 0.7481 |
| 42 | −38.379 | 1.20 | 2.00100 | 29.1 | 0.6838 |
| 43 | 61.949 | 2.58 | | | |
| 44 | −124.665 | 2.97 | 1.85478 | 24.8 | 0.6739 |
| 45 | −25.665 | 1.20 | 1.85920 | 33.0 | 0.6855 |
| 46 | −45.233 | 4.87 | | | |
| 47 | ∞ | 33.00 | 1.60859 | 46.4 | 0.7534 |
| 48 | ∞ | 13.20 | 1.51633 | 64.1 | 0.8687 |
| 49 | ∞ | 7.38 | | | |
| Image plane | ∞ | | | | |

Aspherical Surface Data
13th surface
K = 8.16505e−01 A4 = 1.77105e−06 A6 = 1.42691e−08 A8 = −6.46440e−10
A10 = 1.02519e−11 A12 = −8.25095e−14 A14 = 3.30010e−16 A16 = −5.22438e−19
26th surface
K = −1.84774e+00 A4 = −2.09515e−06 A6 = 1.81035e−09 A8 = 4.21519e−12
A10 = −5.59792e−14 A12 = 1.80787e−16

Various Data
Zoom ratio 26.09

| | Wide-angle end | Intermediate point | Telephoto end |
|---|---|---|---|
| Focal length | 11.50 | 58.64 | 300.00 |
| F-number | 2.70 | 2.70 | 4.89 |
| Half angle of view | 25.56 | 5.36 | 1.05 |
| Image height | 5.50 | 5.50 | 5.50 |
| Entire lens length | 300.04 | 300.04 | 300.04 |
| BF | 7.38 | 7.38 | 7.38 |
| d12 | 1.49 | 57.43 | 78.08 |
| d14 | 6.51 | 5.41 | 11.42 |
| d20 | 56.31 | 2.43 | 7.22 |
| d25 | 15.71 | 21.73 | 1.02 |
| d27 | 19.34 | 12.36 | 1.62 |
| d49 | 7.38 | 7.38 | 7.38 |

Zoom Lens Unit Data

| Unit | Starting surface | Focal length |
|---|---|---|
| 1 | 1 | 100.87 |
| 2 | 13 | −26.80 |
| 3 | 15 | −122.98 |
| 4 | 21 | −48.61 |
| 5 | 26 | 54.69 |
| 6 | 29 | 62.51 |

### NUMERICAL EXAMPLE 6

in mm
Surface Data

| Surface | | | | | |
|---|---|---|---|---|---|
| number | r | d | nd | vd | θct |
| 1 | 180.696 | 7.69 | 1.48749 | 70.2 | 0.8924 |
| 2 | 910.177 | 0.19 | | | |
| 3 | 223.463 | 4.00 | 1.69680 | 55.5 | 0.8330 |
| 4 | 104.591 | 11.07 | 1.43875 | 94.9 | 0.8373 |
| 5 | 461.529 | 0.14 | | | |
| 6 | 157.978 | 4.80 | 1.43387 | 95.1 | 0.8092 |
| 7 | 251.779 | 18.37 | | | |
| 8 | 125.213 | 6.57 | 1.43875 | 94.9 | 0.8373 |
| 9 | 288.377 | 1.40 | 1.75500 | 52.3 | 0.8092 |
| 10 | 86.841 | 0.99 | | | |
| 11 | 85.047 | 12.25 | 1.43875 | 94.9 | 0.8373 |
| 12 | 4208.067 | 1.40 | 1.64000 | 60.1 | 0.8645 |
| 13 | 381.214 | 0.20 | | | |
| 14 | 121.979 | 9.62 | 1.59522 | 67.7 | 0.7953 |
| 15 | 658.818 | (variable) | | | |
| 16 | 488.670 | 0.90 | 1.75106 | 43.1 | 0.7097 |
| 17 | 20.091 | 4.22 | | | |
| 18 | −52.580 | 4.45 | 1.73800 | 32.3 | 0.7154 |
| 19 | −15.126 | 0.80 | 1.69930 | 51.1 | 0.7593 |
| 20 | 60.325 | 0.50 | | | |
| 21 | 36.226 | 2.69 | 1.73800 | 32.3 | 0.7154 |
| 22 | 3647.881 | 2.11 | | | |
| 23 | −25.891 | 0.80 | 1.72000 | 48.0 | 0.7100 |
| 24 | −29.968 | (variable) | | | |
| 25 | −47.579 | 0.80 | 1.71700 | 47.9 | 0.7629 |
| 26 | 47.847 | 2.59 | 1.84666 | 23.8 | 0.6614 |
| 27 | 302.539 | (variable) | | | |
| 28 (aperture) | ∞ | 0.50 | | | |
| 29 | 69.533 | 6.94 | 1.59522 | 67.7 | 0.7953 |
| 30* | −44.153 | 0.09 | | | |
| 31 | 111.080 | 6.91 | 1.43875 | 94.7 | 0.8410 |
| 32 | −28.162 | 0.90 | 1.80610 | 40.9 | 0.7483 |
| 33 | −189.544 | 32.94 | | | |
| 34 | 45.993 | 6.71 | 1.43875 | 94.7 | 0.8410 |
| 35 | −130.394 | 14.52 | | | |
| 36 | 9967.779 | 3.58 | 1.43875 | 94.7 | 0.8410 |
| 37 | −33.126 | 2.01 | | | |
| 38 | −28.148 | 8.56 | 1.65160 | 58.5 | 0.8525 |
| 39 | 18.306 | 2.57 | 1.60342 | 38.0 | 0.7353 |
| 40 | 28.812 | 0.74 | | | |
| 41 | 26.113 | 4.64 | 1.56732 | 42.8 | 0.7589 |
| 42 | −33.479 | 1.57 | | | |
| 43 | 44.750 | 3.60 | 1.54072 | 47.2 | 0.7766 |
| 44 | −24.930 | 0.80 | 1.85026 | 32.3 | 0.6942 |
| 45 | 77.632 | 5.00 | | | |
| 46 | ∞ | 33.00 | 1.60859 | 46.4 | 0.7534 |
| 47 | ∞ | 13.20 | 1.51680 | 64.2 | 0.8698 |
| 48 | ∞ | 7.41 | | | |
| Image plane | ∞ | | | | |

Aspherical Surface Data
30th surface
K = 0.00000e+00 A4 = −1.06062e−07 A6 = −1.17310e−09 A8 = −5.39937e−13
A10 = −1.94022e−15

Various Data
Zoom ratio 20.00

| | Wide-angle end | Intermediate point | Telephoto end |
|---|---|---|---|
| Focal length | 25.00 | 111.80 | 500.00 |
| F-number | 2.90 | 2.90 | 5.00 |
| Half angle of view | 12.41 | 2.82 | 0.63 |
| Image height | 5.50 | 5.50 | 5.50 |
| Entire lens length | 370.61 | 370.61 | 370.61 |
| BF | 7.41 | 7.41 | 7.41 |
| d15 | 22.91 | 80.68 | 104.43 |
| d24 | 77.84 | 11.50 | 9.51 |
| d27 | 15.09 | 23.66 | 1.91 |
| d48 | 7.41 | 7.41 | 7.41 |

Zoom Lens Unit Data

| Unit | Starting surface | Focal length |
|---|---|---|
| 1 | 1 | 169.38 |
| 2 | 16 | −24.07 |
| 3 | 25 | −65.76 |
| 4 | 29 | 46.05 |

### NUMERICAL EXAMPLE 7

in mm
Surface Data

| Surface | | | | | |
|---|---|---|---|---|---|
| number | r | d | nd | vd | θct |
| 1 | −199.291 | 1.50 | 1.74100 | 52.6 | 0.8155 |
| 2 | 92.793 | 0.75 | | | |
| 3 | 93.134 | 11.35 | 1.43387 | 95.1 | 0.8092 |
| 4 | −232.794 | 0.20 | | | |
| 5 | 175.628 | 6.59 | 1.43387 | 95.1 | 0.8092 |
| 6 | −352.777 | 17.06 | | | |
| 7 | 157.316 | 6.90 | 1.43387 | 95.1 | 0.8092 |
| 8 | −320.965 | 0.23 | | | |
| 9 | 118.129 | 6.64 | 1.43387 | 95.1 | 0.8092 |
| 10 | −936.511 | 0.30 | | | |
| 11 | 85.254 | 4.81 | 1.43387 | 95.1 | 0.8092 |
| 12 | 177.732 | (variable) | | | |
| 13* | −300.301 | 0.60 | 1.78000 | 40.0 | 0.6950 |
| 14 | 17.248 | 7.34 | | | |
| 15 | −35.541 | 4.17 | 1.73800 | 32.3 | 0.7154 |
| 16 | −17.070 | 0.80 | 1.75106 | 43.1 | 0.7097 |
| 17 | −211.013 | 0.18 | | | |
| 18 | 57.943 | 4.98 | 1.73800 | 32.3 | 0.7154 |
| 19 | −39.226 | 0.60 | 1.75106 | 43.1 | 0.7097 |
| 20 | −72.989 | (variable) | | | |
| 21 | −353.750 | 0.50 | 1.59410 | 60.5 | 0.7800 |
| 22 | 17.521 | 3.03 | 1.74951 | 35.3 | 0.7308 |
| 23 | 81.160 | 2.70 | | | |
| 24 | −35.674 | 0.50 | 1.59522 | 67.7 | 0.7953 |
| 25 | 68.500 | (variable) | | | |
| 26 (aperture) | ∞ | 0.50 | | | |
| 27* | 36.914 | 4.67 | 1.59522 | 67.7 | 0.7953 |
| 28 | −266.118 | (variable) | | | |
| 29 | 93.731 | 3.66 | 1.43875 | 94.9 | 0.8373 |
| 30 | −61.404 | 0.20 | | | |
| 31 | 84.302 | 3.81 | 1.43875 | 94.9 | 0.8373 |
| 32 | −51.430 | 1.30 | 1.64000 | 60.1 | 0.8645 |
| 33 | 496.250 | 0.20 | | | |
| 34 | 48.219 | 1.30 | 1.64000 | 60.1 | 0.8645 |
| 35 | 24.530 | 33.97 | | | |
| 36 | 30.272 | 5.01 | 1.43875 | 94.9 | 0.8373 |
| 37 | −46.240 | 0.20 | | | |
| 38 | 40.551 | 5.13 | 1.43875 | 94.9 | 0.8373 |
| 39 | −21.793 | 1.00 | 1.65160 | 58.5 | 0.8525 |
| 40 | −33.506 | 1.05 | | | |
| 41 | −40.693 | 0.60 | 1.95375 | 32.3 | 0.6988 |
| 42 | 37.319 | 3.29 | | | |
| 43 | 45.065 | 2.91 | 1.76182 | 26.5 | 0.6757 |
| 44 | −59.647 | 1.00 | 1.88300 | 40.8 | 0.7397 |
| 45 | −672.675 | 4.87 | | | |
| 46 | ∞ | 33.00 | 1.60859 | 46.4 | 0.7534 |
| 47 | ∞ | 13.20 | 1.51633 | 64.1 | 0.8687 |
| 48 | ∞ | 7.39 | | | |
| Image plane | ∞ | | | | |

Aspherical Surface Data
13th surface
K = −1.83093e+00 A4 = 9.28166e−06 A6 = 4.57095e−08 A8 = −1.46641e−09
A10 = 1.79202e−11 A12 = −1.15334e−13 A14 = 3.82298e−16 A16 = −5.14147e−19
27th surface
K = −1.60060e+00 A4 = −2.41963e−06 A6 = 1.17337e−09 A8 = −6.94747e−12
A10 = 1.70256e−14 A12 = −1.33847e−17

Various Data
Zoom ratio 26.09

| | Wide-angle end | Intermediate point | Telephoto end |
|---|---|---|---|
| Focal length | 11.50 | 58.64 | 300.00 |
| F-number | 2.70 | 2.70 | 4.89 |
| Half angle of view | 25.56 | 5.36 | 1.05 |
| Image height | 5.50 | 5.50 | 5.50 |
| Entire lens length | 300.03 | 300.03 | 300.03 |
| BF | 7.39 | 7.39 | 7.39 |
| d12 | 1.79 | 55.13 | 72.25 |
| d20 | 54.14 | 2.02 | 11.37 |
| d25 | 25.58 | 25.44 | 2.56 |
| d28 | 8.53 | 7.45 | 3.87 |
| d48 | 7.39 | 7.39 | 7.39 |

Zoom Lens Unit Data

| Unit | Starting surface | Focal length |
|---|---|---|
| 1 | 1 | 92.49 |
| 2 | 13 | −29.44 |
| 3 | 21 | −36.79 |
| 4 | 27 | 54.78 |
| 5 | 29 | 66.74 |

TABLE 1

| | | FIRST | SECOND | THIRD | FOURTH | FIFTH | SIXTH | SEVENTH |
|---|---|---|---|---|---|---|---|---|
| | | EMBODI- | EMBODI- | EMBODI- | EMBODI- | EMBODI- | EMBODI- | EMBODI- |
| | | MENT | MENT | MENT | MENT | MENT | MENT | MENT |
| INEQUAL- | ndLN | 1.699 | 1.699 | 1.751 | 1.699 | 1.859 | 1.699 | 1.780 |
| ITY (1) | | | | | | | | |
| INEQUAL- | vdLN | 51.11 | 51.11 | 43.10 | 51.11 | 33.00 | 51.11 | 40.00 |
| ITY (2) | | | | | | | | |
| INEQUAL- | θCtLN- | 0.546 | 0.546 | 0.530 | 0.546 | 0.548 | 0.333 | 0.528 |
| ITY (3) | 0.00417 × | | | | | | | |
| | vdLN | | | | | | | |
| INEQUAL- | fLN1/fN1 | 1.3 | 2.3 | 1.0 | 1.4 | 1.0 | 1.2 | 0.7 |
| ITY (4) | | | | | | | | |
| INEQUAL- | f1/fN1 | −5.8 | −6.0 | −7.5 | −8.1 | −3.8 | −7.0 | −3.1 |
| ITY (5) | | | | | | | | |
| INEQUAL- | ndN1a | 1.691 | 1.636 | 1.658 | 1.636 | 1.859 | 1.729 | 1.752 |
| ITY (6) | | | | | | | | |
| INEQUAL- | vdN1p- | −18.7 | −19.1 | −19.1 | −19.1 | — | −15.1 | −9.7 |
| ITY (7) | vdN1n | | | | | | | |
| INEQUAL- | θCtN1p- | −0.023 | −0.010 | −0.013 | −0.010 | — | −0.011 | 0.011 |
| ITY (8) | θCtN1n | | | | | | | |
| INEQUAL- | fLNm/fNm | 1.3 | 0.7 | 1.0 | 1.4 | 1.0 | 1.2 | 0.7 |
| ITY (9) | | | | | | | | |
| INEQUAL- | ndNma | 1.691 | 1.681 | 1.658 | 1.636 | 1.859 | 1.729 | 1.752 |
| ITY (10) | | | | | | | | |
| INEQUAL- | vdNmp- | −18.7 | −24.1 | −19.1 | −19.1 | — | −15.1 | −9.7 |
| ITY (11) | vdNmn | | | | | | | |
| INEQUAL- | θCtNmp- | −0.023 | −0.047 | −0.013 | −0.010 | — | −0.011 | 0.011 |
| ITY (12) | θCtNmn | | | | | | | |
| INEQUAL- | fLNVm/fV | 1.3 | 2.3 | 1.0 | 1.4 | 0.8 | 1.2 | 0.7 |
| ITY (13) | | | | | | | | |
| INEQUAL- | f1/fV | −5.8 | −5.9 | −7.5 | −8.1 | −3.8 | −7.0 | −3.1 |
| ITY (14) | | | | | | | | |
| INEQUAL- | ndVa | 1.691 | 1.636 | 1.658 | 1.636 | 1.748 | 1.729 | 1.752 |
| ITY (15) | | | | | | | | |
| INEQUAL- | vdVp- | −18.7 | −19.1 | −19.1 | −19.1 | −14.6 | −15.1 | −9.7 |
| ITY (16) | vdVn | | | | | | | |
| INEQUAL- | θCtVp- | −0.023 | −0.010 | −0.013 | −0.010 | −0.022 | −0.011 | 0.011 |
| ITY (17) | θCtVn | | | | | | | |
| INEQUAL- | θCt1p- | 0.007 | 0.000 | −0.003 | −0.001 | 0.000 | 0.007 | −0.006 |
| ITY (18) | θCt1n | | | | | | | |

TABLE 2

| | FIRST | SECOND | THIRD | FOURTH | FIFTH | SIXTH | SEVENTH |
|---|---|---|---|---|---|---|---|
| | EMBODI- | EMBODI- | EMBODI- | EMBODI- | EMBODI- | EMBODI- | EMBODI- |
| | MENT | MENT | MENT | MENT | MENT | MENT | MENT |
| ndLN | 1.699 | 1.699 | 1.751 | 1.699 | 1.859 | 1.699 | 1.780 |
| vdLN | 51.11 | 51.11 | 43.10 | 51.11 | 33.00 | 51.11 | 40.00 |
| θCtLN | 0.7593 | 0.7593 | 0.7097 | 0.7593 | 0.6855 | 0.5462 | 0.6950 |
| f1 | 163.84 | 167.49 | 286.02 | 282.68 | 100.87 | 169.38 | 92.49 |
| fLN1 | −37.59 | −64.02 | −38.86 | −48.64 | −26.80 | −27.92 | −20.89 |
| fN1 | −28.11 | −27.85 | −38.26 | −34.71 | −26.80 | −24.07 | −29.44 |
| fLNm | −37.59 | −34.10 | −38.86 | −48.64 | −26.80 | −27.92 | −20.89 |
| fNm | −28.11 | −45.66 | −38.26 | −34.71 | −26.80 | −24.07 | −29.44 |
| fLNVm | −37.59 | −64.02 | −38.86 | −48.64 | −20.86 | −27.92 | −20.89 |
| fV | −28.11 | −27.85 | −38.26 | −34.71 | −26.80 | −24.07 | −29.44 |
| ndN1a | 1.691 | 1.636 | 1.658 | 1.636 | 1.859 | 1.729 | 1.752 |
| vdN1p | 35.30 | 41.31 | 39.80 | 41.31 | — | 32.33 | 32.33 |
| vdN1n | 53.98 | 60.44 | 58.92 | 60.44 | — | 47.40 | 42.07 |
| θCtN1p | 0.7317 | 0.7745 | 0.7566 | 0.7745 | — | 0.7154 | 0.7154 |
| θCtN1n | 0.7548 | 0.7841 | 0.7699 | 0.7841 | — | 0.7263 | 0.7048 |
| ndNma | 1.691 | 1.681 | 1.658 | 1.636 | 1.859 | 1.729 | 1.752 |
| vdNmp | 35.30 | 35.33 | 39.80 | 41.31 | — | 32.33 | 32.33 |
| vdNmn | 53.98 | 59.43 | 58.92 | 60.44 | — | 47.40 | 42.07 |
| θCtNmp | 0.7317 | 0.7308 | 0.7566 | 0.7745 | — | 0.7154 | 0.7154 |
| θCtNmn | 0.7548 | 0.7773 | 0.7699 | 0.7841 | — | 0.7263 | 0.7048 |
| ndVa | 1.691 | 1.636 | 1.658 | 1.636 | 1.748 | 1.729 | 1.752 |
| vdVp | 35.30 | 41.31 | 39.80 | 41.31 | 34.54 | 32.33 | 32.33 |
| vdVn | 53.98 | 60.44 | 58.92 | 60.44 | 49.12 | 47.40 | 42.07 |
| θCtVp | 0.7317 | 0.7745 | 0.7566 | 0.7745 | 0.7282 | 0.7154 | 0.7154 |
| θCtVn | 0.7548 | 0.7841 | 0.7699 | 0.7841 | 0.7499 | 0.7263 | 0.7048 |
| θCt1p | 0.8427 | 0.8092 | 0.8185 | 0.8155 | 0.8092 | 0.8427 | 0.8092 |
| θCt1n | 0.8356 | 0.8092 | 0.8211 | 0.8168 | 0.8092 | 0.8356 | 0.8155 |

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-115908, filed Jul. 20, 2022, which is hereby incorporated by reference herein in its entirety.

What is claimed is:

1. A zoom lens comprising, in order from an object side to an image side:
a first lens unit having positive refractive power, the first lens unit being configured not to move for zooming;
an intermediate group including a plurality of lens units, the plurality of lens units being configured to move for zooming; and
a rear lens unit,
wherein an interval between adjacent lens units changes for zooming,
wherein the intermediate group includes a lens unit having negative refractive power including a negative lens LN that satisfies the following inequalities:
1.60<ndLN<2.00
25.0<vdLN<60.0
0.490<θCtLN−0.00417×vdLN<0.550
where ndLN is a refractive index of a material of the negative lens LN for d-line, vdLN is Abbe number of the material of the negative lens LN for d-line, and θCtLN is a partial dispersion ratio of the material of the negative lens LN for C-line and t-line, and
wherein the following inequality is satisfied:
−0.050<θCtNmp−θCtNmn<0.050
where θCtNmp is an average value of partial dispersion ratios, for C-line and t-line, of all positive lenses included in a lens unit Nm including a negative lens LNm having strongest negative refractive power of the negative lens LN, and θCtNmn is an average value of partial dispersion ratios, for C-line and t-line, of all negative lenses included in the lens unit Nm.

2. The zoom lens according to claim 1, wherein the negative lens LN is included in a lens unit N1 having strongest negative refractive power among the plurality of lens units included in the intermediate group and satisfies the following inequality:
0.3<fLN1/fN1<5.0
where fN1 is a focal length of the lens unit N1, and fLN1 is a focal length of a negative lens LN1 having strongest negative refractive power of the negative lens LN included in the lens unit N1.

3. The zoom lens according to claim 1, wherein the following inequality is satisfied:
−12.0<f1/fN1<−2.0
where f1 is a focal length of the first lens unit, and fN1 is a focal length of a lens unit N1 having strongest negative refractive power among the plurality of lens units included in the intermediate group.

4. The zoom lens according to claim 1, wherein the following inequality is satisfied:
1.55<ndN1a<1.90
where ndN1a is an average value of refractive indices for d-line of all lenses included in a lens unit N1 having strongest negative refractive power among the plurality of lens units included in the intermediate group.

5. The zoom lens according to claim 1, wherein the following inequality is satisfied:
−40.0<vdN1p−vdN1n<−5.0
where vdN1p is an average value of Abbe numbers for d-line of all lenses having positive refractive power included in a lens unit N1 having strongest negative refractive power among the plurality of lens units included in the intermediate group, and vdN1n is an average value of Abbe numbers for d-line of lenses having negative refractive power included in the lens unit N1.

6. The zoom lens according to claim 1, wherein the following inequality is satisfied:
−0.050<θCtN1p−θCtN1n<0.050
where θCtN1p is an average value of partial dispersion ratios, for C-line and t-line, of all lenses having positive refractive power included in a lens unit N1 having strongest negative refractive power among the plurality of lens units included in the intermediate group, and θCtN1n is an average value of partial dispersion ratios, for C-line and t-line, of all lenses having negative refractive power included in the lens unit N1.

7. The zoom lens according to claim 1, wherein the following inequality is satisfied:
0.3<fLNm/fNm<4.0
where fNm is a focal length of the lens unit Nm, and fLNm is a focal length of the negative lens LNm.

8. The zoom lens according to claim 1, wherein the following inequality is satisfied:
1.55<ndNma<1.90
where ndNma is an average value of refractive indices for d-line of all lenses included in the lens unit Nm.

9. The zoom lens according to claim 1, wherein the following inequality is satisfied:
−40.0<vdNmp−vdNmn<−5.0
where vdNmp is an average value of Abbe numbers for d-line of all lenses having positive refractive power included in the lens unit Nm, and vdNmn is an average value of Abbe numbers for d-line of all lenses having negative refractive power included in the lens unit Nm.

10. The zoom lens according to claim 1,
wherein the intermediate group consists of, in order from the object side to the image side, a sub-intermediate unit V having negative refractive power and consisting of a lens unit configured to move monotonically to the image side for zooming, and at least one lens unit, wherein the sub-intermediate unit V includes the negative lens LN, and
wherein the following inequality is satisfied:
0.3<fLNVm/fV<4.0
where fV is a focal length of the sub-intermediate unit V at a wide-angle end, and fLNVm is a focal length of a negative lens LNVm having strongest negative refractive power among the negative lens LN in the sub-intermediate unit V.

11. The zoom lens according to claim 1,
wherein the intermediate group consists of, in order from the object side to the image side, a sub-intermediate unit V having negative refractive power and consisting of a lens unit configured to move monotonically to the image side for zooming, and at least one lens unit, and
wherein the following inequality is satisfied:
−12.0<MA/<−2.0
where f1 is a focal length of the first lens unit, and fv is a focal length of the sub-intermediate unit V at a wide-angle end.

12. The zoom lens according to claim 1,
wherein the intermediate group consists of, in order from the object side to the image side, a sub-intermediate unit V having negative refractive power and consisting of a lens unit configured to move monotonically to the image side for zooming, and at least one lens unit, and
wherein the following inequality is satisfied:
1.55<ndVa<1.9
where ndVa is an average value of refractive indices for d-line of all lenses included in the sub-intermediate unit V.

13. The zoom lens according to claim 1,
wherein the intermediate group consists of, in order from the object side to the image side, a sub-intermediate unit V having negative refractive power and consisting of a lens unit configured to move monotonically to the image side for zooming, and at least one lens unit, and
wherein the following inequality is satisfied:
−40.0<vdVp−vdVn<−5.0
where vdVp is an average value of Abbe numbers for d-line of all lenses having positive refractive power included in the sub-intermediate unit V, and vdVn is an average value of Abbe numbers for d-line of all lenses having negative refractive power included in the sub-intermediate unit V.

14. The zoom lens according to claim 1,
wherein the intermediate group consists of, in order from the object side to the image side, a sub-intermediate unit V having negative refractive power and consisting of a lens unit configured to move monotonically to the image side for zooming, and at least one lens unit, and
wherein the following inequality is satisfied:
−0.050<θCtVp−θCtVn<0.050
where θCtVp is an average value of partial dispersion ratios, for C-line and t-line, of all lenses having positive refractive power included in the sub-intermediate unit V, and θCtVn is an average value of partial dispersion ratios, for C-line and t-line, of all lenses having negative refractive power included in the sub-intermediate unit V.

15. The zoom lens according to claim 1, wherein the following inequality is satisfied:
−0.030<θCt1p−θCt1n<0.030
where θCt1p is an average value of partial dispersion ratios, for C-line and t-line, of all lenses having positive refractive power included in the first lens unit, and θCt1n is an average value of partial dispersion ratios, for C-line and t-line, of all lenses having negative refractive power included in the first lens unit.

16. The zoom lens according to claim 1, further comprising an aperture stop disposed between the intermediate group and the rear lens unit or, in the intermediate group, between a lens unit disposed closest to the image side and a lens unit second closest to the image side.

17. The zoom lens according to claim 16, wherein the aperture stop is configured to move for zooming.

18. The zoom lens according to claim 1, wherein the rear lens unit is configured not to move for zooming

19. A zoom lens comprising, in order from an object side to an image side:
a first lens unit having positive refractive power, the first lens unit being configured not to move for zooming;
an intermediate group including a plurality of lens units, the plurality of lens units being configured to move for zooming; and
a rear lens unit,
wherein an interval between adjacent lens units changes for zooming,
wherein the intermediate group includes a lens unit having negative refractive power including a negative lens LN that satisfies the following inequalities:
1.60<ndLN<2.00
25.0<vdLN<60.0
0.490<θCtLN−0.00417×vdLN<0.550
where ndLN is a refractive index of a material of the negative lens LN for d-line, vdLN is Abbe number of the material of the negative lens LN for d-line, and θCtLN is a partial dispersion ratio of the material of the negative lens LN for C-line and t-line, and
wherein the following inequality is satisfied:
−0.030<θCt1p−θCt1n<0.015
where θCt1p is an average value of partial dispersion ratios, for C-line and t-line, of all lenses having positive refractive power included in the first lens unit, and θCt1n is an average value of partial dispersion ratios, for C-line and t-line, of all lenses having negative refractive power included in the first lens unit.

20. The zoom lens according to claim 19, wherein the following inequality is satisfied:
−40.0<vdN1p−vdN1n<−5.0
where vdN1p is an average value of Abbe numbers for d-line of all lenses having positive refractive power included in a lens unit N1 having strongest negative refractive power among the plurality of lens units included in the intermediate group, and vdN1n is an average value of Abbe numbers for d-line of all lenses having negative refractive power included in the lens unit N1.

21. The zoom lens according to claim 19, wherein the following inequality is satisfied:
−0.050<θCtN1p−θCtN1n<0.050
where θCtN1p is an average value of partial dispersion ratios, for C-line and t-line, of all lenses having positive refractive power included in the lens unit N1 having strongest negative refractive power among the plurality of lens units included in the intermediate group, and θctN1n is an average value, for C-line and t-line, of partial dispersion ratios of all lenses having negative refractive power included in the lens unit N1.

22. The zoom lens according to claim 19, wherein the following inequality is satisfied:
−40.0<vdNmp−vdNmn<−5.0
where vdNmp is an average value of Abbe numbers for d-line of all lenses having positive refractive power included in the lens unit Nm including the negative lens LNm having the strongest negative refractive power in the negative lens LN, and vdNmn is an average value of Abbe numbers for d-line of all lenses having negative refractive power included in the lens unit Nm.

23. The zoom lens according to claim 19,
wherein the intermediate group consists of, in order from the object side to the image side, a sub-intermediate unit V having negative refractive power and consisting of a lens unit configured to move monotonically to the image side for zooming, and at least one lens unit, and
wherein the following inequality is satisfied:
−40.0<vdVp−vdVn<−5.0
where vdVp is an average value of Abbe numbers for d-line of all lenses having positive refractive power included in the sub-intermediate unit V, and vdVn is an average value of Abbe numbers for d-line of all lenses having negative refractive power included in the sub-intermediate unit V.

24. The zoom lens according to claim 19,
wherein the intermediate group consists of, in order from the object side to the image side, a sub-intermediate unit V having negative refractive power and consisting of a lens unit configured to move monotonically to the image side for zooming, and at least one lens unit, and
wherein the following inequality is satisfied:
−0.050<θCtVp−θCtVn<0.050
where θCtVp is an average value of partial dispersion ratios, for C-line and t-line, of all lenses having positive refractive power included in the sub-intermediate unit V, and θCtVn is an average value of partial dispersion ratios, for C-line and t-line, of all lenses having negative refractive power included in the sub-intermediate unit V.

25. An image capturing apparatus comprising:
the zoom lens according to claim 1; and
an image sensor configured to capture an image formed by the zoom lens.
